(19) United States
(12) Patent Application Publication
(10) Pub. No.: US 2012/0077046 A1
(43) Pub. Date: Mar. 29, 2012

(54) Composition for forming hardcoat layer, optical film, method of producing optical film, polarizing plate and image display device

(75) Inventors: Miho Asahi, Kanagawa (JP); Kenichi Fukuda, Kanagawa (JP); Daiki Wakizaka, Kanagawa (JP)

(73) Assignee: FUJIFILM Corporation, Tokyo (JP)

(21) Appl. No.: 13/200,343

(22) Filed: Sep. 23, 2011

(30) Foreign Application Priority Data
Sep. 24, 2010 (JP) 2010-214567

(51) Int. Cl. B32B 27/06; B05D 5/06; C09D 127/12

(52) U.S. Cl. 428/507; 522/79; 427/164

(57) ABSTRACT

A composition for forming a hardcoat layer, contains: at least one antifouling agent selected from a fluorine-containing compound having a polymerizable unsaturated group and a polysiloxane compound having a weight average molecular weight of 15,000 or more and a polymerizable unsaturated group; dimethyl carbonate; a compound having an unsaturated double bond; and a photopolymerization initiator.

### CROSS-REFERENCE TO RELATED APPLICATIONS

This application claims the benefit of Japanese Patent Application JP 2010-214567, filed Sep. 24, 2010, the entire content of which is hereby incorporated by reference, the same as if set forth at length.

### FIELD OF THE INVENTION

The present invention relates to a composition for forming a hardcoat layer, an optical film, a method of producing an optical film, a polarizing plate and an image display device.

### BACKGROUND OF THE INVENTION

In an image display device, for example, a cathode ray tube display device (CRT), a plasma display (PDP), an electroluminescence display (ELD), a vacuum fluorescent display (VFD), a field emission display (FED) or a liquid crystal display device (LCD), a hardcoat film having a hardcoat layer is preferably provided on a transparent base material in order to prevent occurrence of scratch on the surface of display. For the hardcoat layer, as well as a high hardness, a high antifouling property and a high adhesion property to the transparent base material are required.

As a method of imparting the antifouling property to an optical film, for example, a hardcoat film, it is known to add an antifouling agent, for example, a fluorine-containing compound or a polysiloxane compound. For instance, it is described in JP-A-2010-152311 (the term “JP-A” as used herein means an “unexamined published Japanese patent application”) to incorporate an antifouling agent composed of a fluorine-containing compound into a low refractive index layer of an antireflective film.

An antireflective film having an antifouling layer containing a fluorine-containing compound or a silicon-containing compound is described in JP-A-2004-354699.

In the optical film, a fluorine-containing compound or a polysiloxane compound is also used as a surfactant. For instance, it is described in JP-A-2008-134394 that a fluorine-containing compound or a polysiloxane compound may be added as a surfactant to an antiglare film of an antireflective film.

Further, separately, it is described in JP-A-2007-268420 or JP-A-2010-20267 to use dimethyl carbonate as a solvent in a composition for forming a hardcoat layer or a composition for forming an antiglare film.

### SUMMARY OF THE INVENTION

However, the techniques described in JP-A-2010-152311, JP-A-2004-354699, JP-A-2008-134394, JP-A-2007-268420 and JP-A-2010-20267 are still insufficient to provide an optical film having a hardcoat layer excellent in film strength and excellent in an antifouling property and an adhesion property to a transparent base material.

An object of the present invention is to provide a composition for forming a hardcoat layer capable of providing a hardcoat layer excellent in film hardness and excellent in an antifouling property and an adhesion property to a transparent base material.

Another object of the invention is to provide an optical film having a hardcoat layer excellent in film hardness and excellent in an adhesion property thereof to a transparent base material and an antifouling property.

A still another object of the invention is to provide a method of producing the optical film, a polarizing plate using the optical film as a protective film for the polarizing plate and an image display device having the optical film or polarizing plate.

As a result of the investigations by the inventors, it has been found that in order for an antifouling agent to exert an excellent antifouling function in a small amount of the addition, it is preferred that the antifouling agent is localized in the surface of hardcoat layer. It has been also found that when the antifouling agent is not localized in the surface of hardcoat layer but uniformly distributed in the inside of hardcoat layer, the antifouling function degrades and the hardness of the hardcoat layer is apt to decrease.

The inventors have been made further investigations on the localization of antifouling agent and as a result, it has been ascertained that a solvent used in a composition for forming a hardcoat layer has a large effect on the localization of antifouling agent (eventually improvement in the antifouling property) and it has been found that a hardcoat layer excellent in film strength and excellent in an antifouling property and an adhesion property to a transparent base material can be provided by using particularly dimethyl carbonate and a specific antifouling agent to complete the invention.

Specifically, the problems described above can be solved to achieve the objects by the means described below.

(1) A composition for forming a hardcoat layer containing (a), (b), (c) and (d) shown below:

(a): at least one antifouling agent selected from a fluorine-containing compound having a polymerizable unsaturated group and a polysiloxane compound having a weight average molecular weight of 15,000 or more and a polymerizable unsaturated group,

(b): dimethyl carbonate,

(c): a compound having an unsaturated double bond,

(d): a photopolymerization initiator.

(2) The composition for forming a hardcoat layer as described in (1) above, wherein the antifouling agent (a) is a fluorine-containing compound having a polymerizable unsaturated group, and the fluorine-containing compound has a perfluoropolyether group and a plurality of polymerizable unsaturated groups in its molecule.
(3) The composition for forming a hardcoat layer as described in (2) above, wherein the fluorine-containing compound has four or more polymerizable unsaturated groups in its molecule.
(4) The composition for forming a hardcoat layer as described in (2) or (3) above, wherein the fluorine-containing compound has a perfluoropolyether group represented by —(CF₂O)ₚ—(CF₂CF₂O)_{q}— (wherein p and q each independently represents an integer from 0 to 20, provided that p+q is an integer of 1 or more).
(5) The composition for forming a hardcoat layer as described in anyone of (2) to (4) above, wherein a weight average molecular weight of the fluorine-containing compound is from 1,000 to less than 5,000.
(6) The composition for forming a hardcoat layer as described in (1) above, wherein the antifouling agent (a) is a polysiloxane compound having a weight average molecular weight of 15,000 or more and a polymerizable unsaturated group, and the polysiloxane compound is a dimethylsiloxane having a plurality of polymerizable unsaturated groups in its molecule.
(7) The composition for forming a hardcoat layer as described in any one of (1) to (6) above, wherein a surface tension of the antifouling agent (a) is 25.0 mN/m or less.
(8) The composition for forming a hardcoat layer as described in any one of (1) to (7) above, which further contains (e) a silica fine particle.
(9) The composition for forming a hardcoat layer as described in anyone of (1) to (8) above, the compound having an unsaturated double bond (c) has a hydrogen-bonding substituent.
(10) The composition for forming a hardcoat layer as described in any one of (1) to (9) above, which further contains a conductive compound.
(11) The composition for forming a hardcoat layer as described in any one of (1) to (10) above, wherein a content of the dimethyl carbonate (b) is 10% by weight or more based on a total solvent.
(12) An optical film having on a transparent base material, a hardcoat layer formed from the composition for forming a hardcoat layer as described in any one of (1) to (11) above.
(13) The optical film as described in (12) above, wherein the transparent base material is a cellulose acylate film.
(14) A polarizing plate using the optical film as described in (12) or (13) above as a protective film for the polarizing plate.
(15) An image display device having the optical film as described in (12) or (13) above or the polarizing plate as described in (14) above.
(16) A method of producing an optical film having a hardcoat layer on a cellulose acylate film base material comprising a step of coating the composition for forming a hardcoat layer as described in any one of (1) to (11) above on the cellulose acylate film base material and curing it to form a hardcoat layer.

According to the present invention, a composition for forming a hardcoat layer capable of providing a hardcoat layer excellent in film hardness and excellent in an antifouling property and an adhesion property to a transparent base material can be provided. Also, an optical film having a hardcoat layer excellent in film hardness and excellent in an adhesion property thereof to a transparent base material and an antifouling property can be provided.

Further, a method of producing the optical film, a polarizing plate using the optical film as a protective film for the polarizing plate and an image display device having the optical film or polarizing plate can be provided.

### DETAILED DESCRIPTION OF THE INVENTION

The mode for carrying out the invention will be described in detail below, but the invention should not be construed as being limited thereto. In the specification, when a numerical value represents a physicality value, a characteristic value or the like, the expression “(numerical value 1) to (numerical value 2)” means “from (numerical value 1) or more to (numerical value 2) or less”. Also, in the specification, the term “(meth)acrylate” means “at least any one of acrylate and methacrylate”. The terms “(meth) acrylic acid”, “(meth)acryloyl” and the like are also same as above.

Further, in the invention, the term “repeating unit corresponding to a monomer” or “repeating unit derived from a monomer” means that a component obtained after polymerization of the monomer forms a repeating unit.

The composition for forming a hardcoat layer according to the invention contains (a), (b), (c) and (d) shown below:

(a): at least one antifouling agent selected from a fluorine-containing compound having a polymerizable unsaturated group and a polysiloxane compound having a weight average molecular weight of 15,000 or more and a polymerizable unsaturated group,

(b): dimethyl carbonate,

(c): a compound having an unsaturated double bond,

(d): a photopolymerization initiator.

### [(a) Antifouling Agent]

At least one antifouling agent (a) selected from a fluorine-containing compound having a polymerizable unsaturated group and a polysiloxane compound having a weight average molecular weight of 15,000 or more and a polymerizable unsaturated group, which is contained in the composition for forming a hardcoat layer according to the invention is described below.

### [Fluorine-Containing Compound Having Polymerizable Unsaturated Group]

The fluorine-containing compound (hereinafter, also referred to as a “fluorine-containing antifouling agent”) having a polymerizable unsaturated group according to the invention is described below.

The fluorine-containing antifouling agent according to the invention is preferably a fluorine-based compound having a structure represented by formula (F) shown below.

(Rf)—[(W)—(R_{A})ₙ]ₘ Formula (F)

In formula (F), Rf represents a (per)fluoroalkyl group or a (per)fluoropolyether group, W represents a connecting group, R_{A} represents a polymerizable unsaturated group, n represents an integer from 1 to 3, and m represents an integer from 1 to 3.

It is believed that the fluorine-containing antifouling agent according to the invention exhibits effects (1) to (3) shown below because of containing the polymerizable unsaturated group.

(1) Since solubility in an organic solvent and compatibility, for example, with a compound having an unsaturated double bond are increased, it is believed that the antifouling agents do not form an aggregate and can be localized uniformly in the surface. Also, the occurrence of defect due to the aggregate can be prevented.

(2) Since the fluorine-containing antifouling agents can form a covalent bond upon a photopolymerization reaction with each other or with a compound having an unsaturated double bond even when the fluorine-containing antifouling agents are localized in the surface, peeling off of the antifouling agent due to abrasion and eventually deterioration of the antifouling property can be prevented.

(3) Loss of the antifouling property and degradation of appearance due to bleeding out and precipitation of the antifouling agent can be prevented.

In formula (F), R_{A} represents a polymerizable unsaturated group. The polymerizable unsaturated group is not particularly limited as long as it is a group capable of causing a radical polymerization reaction upon irradiation of an active energy ray, for example, an ultraviolet ray or an electron beam and includes, for example, a (meth)acryloyl group, a (meth)acryloyloxy group, a vinyl group and an allyl group. A (meth)acryloyl group, a (meth)acryloyloxy group and groups wherein an appropriate hydrogen atom of these groups is substituted with a fluorine atom are preferably used.

Specific examples, of the polymerizable unsaturated group preferably include those shown below.

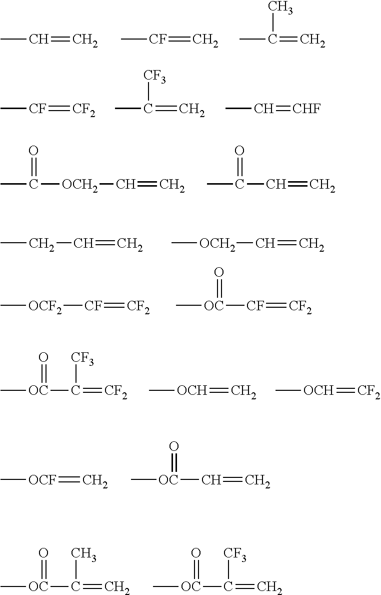

In formula (F), Rf represents a (per)fluoroalkyl group or a (per)fluoropolyether group.

The term “(per)fluoroalkyl group” as used herein means at least one of a fluoroalkyl group and a perfluoroalkyl group and the term “(per)fluoropolyether group” means at least one of a fluoropolyether group and a perfluopolyether group. From the standpoint of the antifouling property, it is preferred that the fluorine content in Rf is high.

The (per)fluoroalkyl group is preferably that having from 1 to 20 carbon atoms, and more preferably that having from 1 to 10 carbon atoms.

The (per)fluoroalkyl group may have a straight-chain structure (for example, —CF₂CF₃, —CH₂ (CF₂)₄H, —CH₂ (CF₂)₈CF₃ or —CH₂CH₂(CF₂)₄H), a branched structure (for example, —CH(CF₃)₂, —CH₂CF (CF₃)₂, —CH(CH₃)CF₂CF₃ or —CH(CH₃)(CF₂)₅CF₂H) or an alicyclic structure (preferably, a 5-membered or 6-membered ring structure, for example, a perfluorocyclohexyl group, a perfluorocyclopentyl group or an alkyl group substituted with each of these groups).

The (per)fluoropolyether group represents a (per)fluoroalkyl group including an ether bond and may be a monovalent group or divalent or higher valent group. The fluoropolyether group includes, for example, —CH₂OCH₂CF₂CF₃, —CH₂CH₂OCH₂C₄F₈H, —CH₂CH₂OCH₂CH₂C₈F₁₇, —CH₂CH₂OCF₂CF₂OCF₂CF₂H and a fluorocycloalkyl group having 4 or more fluorine atoms and from 4 to 20 carbon atoms. The perfluoropolyether group includes, for example, —(CF₂O)ₚ—(CF₂CF₂O)_{q}—, —[CF(CF₃)CF₂O]ₚ—[CF₂ (CF₃)]—, —(CF₂CF₂CF₂O)ₚ— and —(CF₂CF₂O)ₚ—.

The total number of p and q is preferably from 1 to 83, more preferably from 1 to 43, and most preferably from 5 to 23.

Because of the excellent antifouling property, it is particularly preferred that the fluorine-containing antifouling agent according to the invention has a perfluoropolyether group represented by —(CF₂O)ₚ—(CF₂CF₂O)_{q}—.

In the above formula, p and q each independently represents an integer from 0 to 20, provided that p+q is an integer of 1 or more.

According to the invention, from the standpoint of achieving more remarkably the effects (1) to (3) described above, the fluorine-containing antifouling agent preferably has a perfluoropolyether group and a plurality of polymerizable unsaturated groups in its molecule.

In formula (F), W represents a connecting group. W includes, for example, an alkylene group, an arylene group, a heteroalkylene group and a connecting group formed by combination of these groups. The connecting group may further have a functional group, for example, an oxy group, a carbonyl group, a carbonyloxy group, a carbonylimino group, a sulfonamido group or a functional group formed by combination thereof.

W is preferably an ethylene group, and more preferably an ethylene group combined with a carbonylimino group.

The fluorine atom content in the fluorine-containing antifouling agent is not particularly limited and is preferably 20% by weight or more, particularly preferably from 30 to 70% by weight, and most preferably from 40 to 70% by weight.

Examples of the preferable fluorine-containing antifouling agent include R-2020, M-2020, R-3833, M-3833 and OPTOOL DAC (all trade names, produced by Daikin Industries, Ltd.) and MEGAFAC F-171, MEGAFAC F-172, MEGAFAC F-179A, DEFENSA MCF-300 and DEFENSA MCF-323 (all trade names, produced by Dainippon Ink & Chemicals, Inc.), but the invention should not be construed as being limited thereto.

From the standpoint of achieving more remarkably the effects (1) to (3) described above, the product of n and m (n×m) in formula (F) is preferably 2 or more, and more preferably 4 or more.

In the case where both n and m represent 1 at the same time in formula (F), specific examples of preferred embodiment include compounds represented by formulae (F-1) to (F-3) shown below.

Rf²(CF₂CF₂)ₚR′²CH₂CH₂R²OCOCR¹═CH₂ Formula (F-1)

In formula (F-1), Rf² represents a fluorine atom or a fluoroalkyl group having from 1 to 10 carbon atoms, R¹ represents a hydrogen atom or a methyl group, R² represents a single bond or an alkylene group, R′² represents a single bond or a divalent connecting group, p represents an integer indicating a polymerization degree, and the polymerization degree p is not less than k (in which k represents an integer of 3 or more).

In the case where R′² represents a divalent connecting group, the divalent connecting group is same as that described for W above.

Examples of the telomeric acrylate containing a fluorine atom in formula (F-1) include partially or fully fluorinated alkyl ester derivatives of (meth)acrylic acid.

Specific examples of the compound represented by formula (F-1) are set forth below, but the invention should not be construed as being limited thereto.

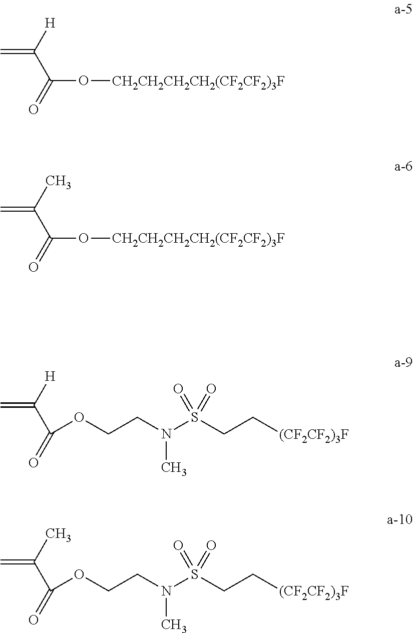

The compound represented by formula (F-1) may comprise a plurality of fluorine-containing (meth)acrylates in which p in the group, Rf²(CF₂CF₂)ₚR′²CH₂CH₂R²O—, of formula (F-1) is each k, k+1, k+2, . . . , or the like, according to telomerization condition, separation condition of a reaction mixture or the like, in the case of using the telomerization in the synthesis thereof.

F(CF₂)_{q}—CH₂—CHX—CH₂Y Formula (F-2)

In formula (F-2), q represents an integer from 1 to 20, and X and Y each independently represents any of a (meth)acryloyloxy group and a hydroxy group, provided that at least one of X and Y represents a (meth)acryloyloxy group.

The fluorine-containing (meth)acrylate represented by formula (F-2) has a fluoroalkyl group having from 1 to 20 carbon atoms which has a trifluoromethyl group (CF₃—) at its terminal, and as for the fluorine-containing (meth)acrylate, the trifluoromethyl group is effectively oriented on the surface even in the case of using a small amount thereof.

From the standpoint of antifouling property and ease of production, q is preferably from 6 to 20, and more preferably from 8 to 10. The fluorine-containing (meth)acrylate having a fluoroalkyl group having from 8 to 10 carbon atoms is excellent in the antifouling property since it exhibits excellent water/oil repellency, in comparison with a fluorine-containing (meth)acrylates having a fluoroalkyl group of other chain-length.

Specific examples of the fluorine-containing (meth)acrylate represented by formula (F-2) include
1-(meth)acryloyloxy-2-hydroxy-4,4,5,5,6,6,7,7,8,8,9,9,10,10,11,11,12,12,13,13,13-heneicosafluorotridecane,
2-(meth)acryloyloxy-1-hydroxy-4,4,5,5,6,6,7,7,8,8,9,9,10,10,11,11,12,12,13,13,13-heneicosafluorotridecane and
1,2-bis(meth)acryloyloxy-4,4,5,5,6,6,7,7,8,8,9,9,10,10,11,11,12,12,13,13,13-heneicosafluorotridecane. In the invention, 1-acryloyloxy-2-hydroxy-4,4,5,5,6,6,7,7,8,8,9,9,10,10,11,11,12,12,13,13,13-heneicosafluorotridecane is preferred.

F(CF₂)ᵣO(CF₂CF₂O)ₛCF₂CH₂OCOCR³═CH₂ Formula (F-3)

In formula (F-3), R³ represents a hydrogen atom or a methyl group, s represents an integer from 1 to 20, and r represents an integer from 1 to 4.

The fluorine atom-containing monofunctional (meth)acrylate represented by formula (F-3) can be obtained by reacting a fluorine atom-containing alcohol compound represented by formula (FG-3) shown below with a (meth)acrylic acid halide.

F(CF₂)ᵣO(CF₂CF₂O)ₛCF₂CH₂OH Formula (FG-3)

In formula (FG-3), s represents an integer from 1 to 20 and r represents an integer from 1 to 4.

Specific examples of the fluorine atom-containing alcohol compound represented by formula (FG-3) include
1H,1H-perfluoro-3,6-dioxaheptan-1-ol,
1H,1H-perfluoro-3,6-dioxaoctan-1-ol,
1H,1H-perfluoro-3,6-dioxadecan-1-ol,
1H,1H-perfluoro-3,6,9-trioxadecan-1-ol,
1H,1H-perfluoro-3,6,9-trioxaundecan-1-ol,
1H,1H-perfluoro-3,6,9-trioxamidecan-1-ol,
1H,1H-perfluoro-3,6,9,12-tetraoxamidecan-1-ol,
1H,1H-perfluoro-3,6,9,12-tetraoxatetradecan-1-ol,
1H,1H-perfluoro-3,6,9,12-tetraoxahexadecan-1-ol,
1H,1H-perfluoro-3,6,9,12,15-pentaoxahexadecan-1-ol,
1H,1H-perfluoro-3,6,9,12,15-pentaoxaheptadecan-1-ol,
1H,1H-perfluoro-3,6,9,12,15-pentaoxanonadecan-1-ol,
1H,1H-perfluoro-3,6,9,12,15,18-hexaoxaeicosan-1-ol,
1H,1H-perfluoro-3,6,9,12,15,18-hexaoxadocosan-1-ol,
1H,1H-perfluoro-3,6,9,12,15,18,21-heptaoxatricosan-1-ol, and
1H,1H-perfluoro-3,6,9,12,15,18,21-heptaoxapentacosan-1-ol.

These compounds are commercially available, and specific examples thereof include, 1H,1H-perfluoro-3,6-dioxaheptan-1-ol: trade name: C5GOL, produced by Exfluor Research Corp., 1H,1H-perfluoro-3,6,9-trioxadecan-1-ol: trade name: C7GOL, produced by Exfluor Research Corp., 1H,1H-perfluoro-3,6-dioxadecan-1-ol: trade name: C8GOL: produced by Exfluor Research Corp., 1H,1H-perfluoro-3,6,9-trioxamidecan-1-ol: trade name: C10GOL: produced by Exfluor Research Corp., 1H,1H-perfluoro-3,6,9,12-tetraoxahexadecan-1-ol: trade name: C12GOL: produced by Exfluor Research Corp.

In the invention, 1H,1H-perfluoro-3,6,9,12-tetraoxamidecan-1-ol is preferably used.

Examples of the (meth)acrylic acid halide to be reacted with the fluorine atom-containing alcohol compound represented by formula (FG-3) include (meth) acrylic acid fluoride, (meth)acryl acid chloride, (meth)acrylic acid bromide and (meth)acrylic acid iodide, and (meth)acrylic acid chloride is preferred from the standpoint of easy availability.

Preferable specific examples of the compound represented by formula (F-3) are set forth below, but the invention should not be construed as being limited thereto. Preferable specific examples of the compound represented by formula (F-3) are also described in JP-A-2007-264221.

F₉C₄OC₂F₄OC₂F₄OCF₂CH₂OCOCH═CH₂ (b-1):

F₉C₄OC₂F₄OC₂F₄OCF₂CH₂OCOC(CH₃)═CH₂ (b-2):

Moreover, separately from the compound represented by formula (F-3), a fluorine-containing unsaturated compound represented by formula (F-3)′ shown below can also be preferably used.

Rf³—[(O)_{c}(O═C)_{b}(CX⁴X⁵)ₐ—CX³═CX¹X²] Formula (F-3)′

In formula (F-3)′, X¹ and X² each independently represents H or F, X³ represents H, F, CH₃ or CF₃, X⁴ and X⁵ each independently represents H, F or CF₃, a, b, and c each independently represents 0 or 1, and Rf³ represents a fluorine-containing alkyl group which contains an ether bond, has 18 to 200 carbon atoms and includes 6 or more repeating units represented by formula (FG-3)′ shown below.

—(CX⁶₂CF₂CF₂O)— Formula (FG-3)

In formula (FG-3)′, X⁶ represents F or H.

Examples of the fluorine-containing polyether compound represented by formula (F-3)′ include:

Rf³-[(O)(O═C)_{b}—CX³═CX¹X²] (c-1):

Rf³-[(O)(O═C)—CX³═CX¹X²] (c-2):

Rf³—[(O)_{c}(O═C)—CF═CH₂] (c-3):

As the polymerizable unsaturated group in the fluorine-containing polyether compound, groups containing the structure shown below are preferably used. The definition of each symbol in (c-1) to (c-3) is same as that in formula (FG-3)′.

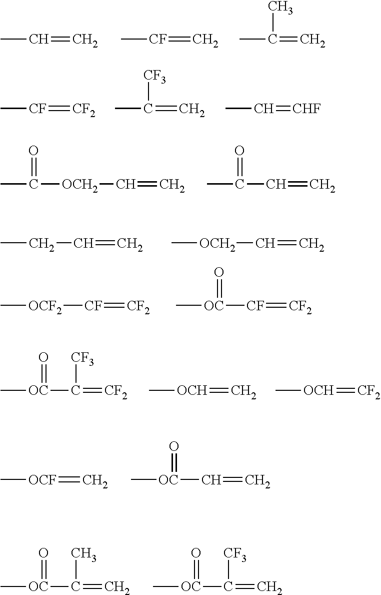

The fluorine-containing polyether compound represented by formula (F-3)′ may have a plurality of the polymerizable unsaturated groups. The structures shown below are preferably exemplified.

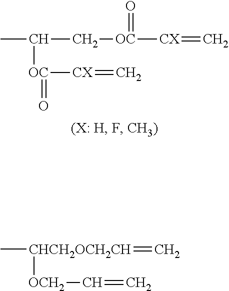

In the invention, the fluorine-containing polyether compound having a structure of —O(C═O)CF═CH₂ is preferred since the polymerization (curing) reactivity is particularly high so that a cured compound can be efficiently obtained.

As for the Rf³ group in the fluorine-containing polyether compound represented by formula (F-3)′, it is important that the Rf³ group contains 6 or more repeating units of the fluorine-containing polyether chain of formula (FG-3)′, whereby the antifouling property can be imparted.

More specifically, although a mixture containing the compound having 6 or more repeating units of the fluorine-containing polyether chain may be used, in the case of using the form of a mixture, the mixture in which in the distribution of the fluorine-containing unsaturated compound having less than 6 repeating units and the fluorine-containing unsaturated compound having 6 or more repeating units, the present ratio of the fluorine-containing unsaturated compound having 6 or more repeating units of the polyether chain is highest is preferred.

A number of the repeating units of the fluorine-containing polyether chain of formula (FG-3)′ is preferably 6 or more, more preferably 10 or more, still more preferably 18 or more, and particularly preferably 20 or more. Thus, the antifouling property, particularly the property of removing stain including a fat or oil component as well as water repellency can be improved. Also, a gas permeation property can be more effectively imparted. The fluorine-containing polyether chain may be present at the terminal of the Rf³ group or in the chain of the Rf³ group.

Specifically, the Rf³ group preferably has a structure represented by formula (c-4) shown below.

R⁴—(CX⁶₂CF₂CF₂O)ₜ—(R⁵)ₑ— Formula (c-4)

In formula (c-4), X⁶ has the same meaning as defined in formula (FG-3)′, R⁴ represents at least one selected from a hydrogen atom, a halogen atom, an alkyl group, a fluorine-containing alkyl group, an alkyl group containing an ether bond and a fluorine-containing alkyl group containing an ether bond, R⁵ represents a divalent or higher valent organic group, t represents an integer from 6 to 66, and e represents 0 or 1.

That is, the Rf³ group is a fluorine-containing organic group which is connected to a reactive carbon-carbon double bond through the divalent or higher valent organic group represented by R⁵ and has R⁴ at the terminal.

R⁵ may be any organic group capable of connecting the fluorine-containing polyether chain of formula (FG-3)′ to the reactive carbon-carbon double bond and is selected, for example, from an alkylene group, a fluorine-containing alkylene group, an alkylene group containing an ether bond and a fluorine-containing alkylene group containing an ether bond. Among them, a fluorine-containing alkylene group or a fluorine-containing alkylene group containing an ether bond is preferred from the standpoint of transparency and low refractivity.

As specific examples of the fluorine-containing polyether compound represented by formula (F-3)′, compounds described in WO 2003/022906 are preferably used. In the invention, CH₂═CF—COO—CH₂CF₂CF₂—(OCF₂CF₂CF₂)₇—OC₃F₇ can be particularly preferably used.

In the case where n and m are not 1 at the same time in formula (F), preferred embodiments include compounds represented by formulae (F-4) and (F-5) shown below.

(Rf¹)—[(W)—(R_{A})ₙ]ₘ Formula (F-4)

In formula (F-4), Rf¹ represents a (per)fluoroalkyl group or a (per)fluoropolyether group, W represents a connecting group, and R_{A} represents a functional group having an unsaturated double bond, n represents an integer from 1 to 3, and m represents an integer from 1 to 3, provided that n and m are not 1 at the same time.

From the standpoint of excellent water/oil repellency and excellent enduring water/oil repellency (antifouling durability), it is preferred that n represents 2 or 3 and m represents 1 to 3. It is more preferred that n represents 2 or 3 and m represents 2 or 3. It is most preferred that n represents 3 and m represents 2 or 3.

The group represented by Rf¹ is any one of a monovalent group to a trivalent group. In the case where Rf¹ is a monovalent group, the terminal group is preferably (CₙF₂ₙ₊₁)—, (CₙF₂ₙ₊₁O)—, (XCₙF₂ₙO)— or (XCₙF₂ₙ₊₁)— (wherein X is a hydrogen atom, a chlorine atom or a bromine atom, and n is an integer from 1 to 10). Specifically, for example, CF₃O(C₂F₄O)ₚCF₂—, C₃F₇O(CF₂CF₂CF₂O)ₚCF₂CF₂—, C₃F₇O(CF (CF₃)CF₂O)ₚCF(CF₃)— and F(CF(CF₃)CF₂O)ₚCF(CF₃)— can be preferably used.

In the above formulae, p represents an average number from 0 to 50, preferably from 3 to 30, more preferably from 3 to 20, and most preferably from 4 to 15.

In the case where Rf¹ is a divalent group, for example, —(CF₂O)_{q}(C₂F₄O)ᵣCF₂—, —(CF₂)₃O(C₄F₈O)ᵣ(CF₂)₃—, —CF₂O(C₂F₄O)ᵣCF₂—, —C₂F₄O(C₃F₆O)ᵣC₂F₄— and —CF(CF₃)(OCF₂CF(CF₃))ₛOCₜF₂ₜO(CF (CF₃)CF₂O)ᵣCF(CF₃)— can be preferably used.

In the above formulae, q, r and s each represents an average number from 0 to 50, preferably from 3 to 30, more preferably from 3 to 20, and most preferably from 4 to 15. t represents an integer from 2 to 6.

Preferable specific examples and synthesis methods of the compound represented by formula (F-4) are described in WO 2005/113690.

Specific examples of the compound represented by formula (F-4) are set forth below, but the invention should not be construed as being limited thereto. In the specific examples below, “HFPO—” represents a group of F(CF(CF₃)CF₂O)ₚCF(CF₃)— wherein p represents an average number from 6 to 7, and “—HFPO—” represents a group of —(CF(CF₃)CF₂O)ₚCF(CF₃)— wherein p represents an average number from 6 to 7.

HFPO—CONH—C—(CH₂OCOCH═CH₂)₂CH₂CH₃ (d-1):

HFPO—CONH—C—(CH₂OCOCH═CH₂)₂H (d-2):

Michael addition polymerization product of HFPO—CONH—C₃H₆NHCH₃ and trimethylolpropane triacrylate (1:1) (d-3):

(CH₂═CHCOOCH₂)₂H—C—CONH—HFPO—CONH—C—(CH₂OCOCH═CH₂)₂H (d-4):

(CH₂═CHCOOCH₂)₃—C—CONH—HFPO—CONH—C—(CH₂OCOCH═CH₂)₃ (d-5):

Further, a compound represented by formula (F-5) is used as a compound represented by formula (F-4).

CH₂═CX₁—COO—CHY—CH₂—OCO—CX₂═CH₂ Formula (F-5)

In formula (F-5), X₁ and X₂ each independently represents a hydrogen atom or a methyl group, and Y represents a fluoroalkyl group having from 2 to 20 carbon atoms and containing 3 or more fluorine atoms or a fluorocycloalkyl group having from 4 to 20 carbon atoms and containing 4 or more fluorine atoms.

In the invention, the compound having a (meth)acryloyloxy group as the polymerizable unsaturated group may have a plurality of (meth)acryloyloxy groups. By using the fluorine-containing antifouling agent having a plurality of (meth)acryloyloxy groups, a three-dimensional network structure is formed upon curing whereby a high glass transition temperature, a low transfer property of the antifouling agent and improvement in the durability against repeated wiping off of stain can be achieved. Further, a cured film excellent in heat resistance, weather resistance and the like can be obtained.

Specific examples of the compound represented by formula (F-5) preferably include di(meth)acrylic acid-2,2,2-trifluoroethyl ethylene glycol, di(meth)acrylic acid-2,2,3,3,3-pentafluoropropyl ethylene glycol, di(meth)acrylic acid-2,2,3,3,4,4,4-heptafluorobutyl ethylene glycol, di(meth)acrylic acid-2,2,3,3,4,4,5,5,5-nonafluoropentyl ethylene glycol, di(meth)acrylic acid-2,2,3,3,4,4,5,5,6,6,6-undecafluorohexyl ethylene glycol, di(meth)acrylic acid-2,2,3,3,4,4,5,5,6,6,7,7,7-tridecafluoroheptyl ethylene glycol, di(meth)acrylic acid-2,2,3,3,4,4,5,5,6,6,7,7,8,8,8-pentadecafluorooctyl ethylene glycol, di(meth)acrylic acid-3,3,4,4,5,5,6,6,7,7,8,8,8-tridecafluorooctyl ethylene glycol, di(meth)acrylic acid-2,2,3,3,4,4,5,5,6,6,7,7,8,8,9,9,9-heptadecafluorononyl ethylene glycol, di(meth)acrylic acid-2,2,3,3,4,4,5,5,6,6,7,7,8,8,9,9,10,10,10-nonadecafluorodecyl ethylene glycol, di(meth)acrylic acid-3,3,4,4,5,5,6,6,7,7,8,8,9,9,10,10,10-heptadecafluorodecyleth ylene glycol, di(meth)acrylic acid-2-trifluoromethyl-3,3,3-trifluoropropyl ethylene glycol, di(meth)acrylic acid-3-trifluoromethyl-4,4,4-trifluorobutyl ethylene glycol, di(meth)acrylic acid-1-methyl-2,2,3,3,3-pentafluoropropyl ethylene glycol, di(meth)acrylic acid-1-methyl-2,2,3,3,4,4,4-heptafluorobutyl ethylene glycol. These compounds may be used individually or as a mixture. In order to prepare such a di(meth) acrylic acid ester, a known method as described in JP-A-6-306326 can be used. In the invention, diacrylic acid-2,2,3,3,4,4,5,5,6,6,7,7,8,8,9,9,9-heptadecafluorononyl ethylene glycol is preferably used.

In the invention, the compound having a (meth) acryloyloxy group as the polymerizable unsaturated group may be a compound having a plurality of (per)fluoroalkyl groups or (per)fluoropolyether groups in its molecule.

The fluorine-containing antifouling agent according to the invention may be any of a monomer, an oligomer and a polymer.

It is preferred that the fluorine-containing antifouling agent has a substituent which contributes bond formation or compatibility in the film of a hardcoat layer. The substituents are preferably present two or more and may be the same or different from each other. Examples of the preferable substituent include an acryloyl group, a methacryloyl group, a vinyl group, an allyl group, a cinnamoyl group, an epoxy group, an oxethanyl group, a hydroxyl group, a polyoxyalkylene group, a carboxyl group and an amino group.

The fluorine-containing antifouling agent may be a polymer or oligomer with a compound which does not contain a fluorine atom.

The fluorine-containing compound having a polymerizable unsaturated group of component (a) may contain a silicon atom, may contain a siloxane structure or may contain a structure other than the siloxane structure. In the case where the fluorine-containing compound having a polymerizable unsaturated group contains a siloxane structure, the weight average molecular weight thereof is less than 15,000.

In the case where the fluorine-containing compound contains a siloxane structure, the compound is preferably represented by formula (F-6) shown below.

RₐR^{f}_{b}R^{A}_{c}SiO_{(4-a-b-c)/2} Formula (F-6)

In formula (F-6), R represents a hydrogen atom, a methyl group, an ethyl group, a propyl group or a phenyl group, R^{f} represents an organic group containing a fluorine atom, R^{A} represents an organic group containing a polymerizable unsaturated group, 0<a, 0<b, 0<c, and a+b+c<4.

a is preferably from 1 to 1.75, and more preferably from 1 to 1.5. When a is 1 or more, synthesis of the compound is industrially easy, whereas when a is 1.75 or less, compatibility between the curing property and the antifouling property can be easily attained.

The polymerizable unsaturated group in R^{A} includes the polymerizable unsaturated group for R_{A} in formula (F) described above and preferably includes a (meth) acryloyl group, a (meth) acryloyloxy group and groups wherein an appropriate hydrogen atom of these groups is substituted with a fluorine atom.

In the case where the fluorine-containing compound contains a siloxane structure, the siloxane structure preferably includes a compound chain containing a plurality of dimethylsilyloxy units as a repeating unit and having a substituent at a terminal and/or in a side chain. The compound chain containing a dimethylsilyloxy unit as a repeating unit may further contain a structure unit other than the dimethylsilyloxy unit. The substituents are preferably present two or more and may be the same or different from each other. Examples of the preferable substituent include a (meth)acryloyl group, a (meth)acryloyloxy group, a vinyl group, an allyl group, a cinnamoyl group, an epoxy group, an oxethanyl group, a hydroxy group, a fluoroalkyl group, a polyoxyalkylene group, a carboxyl group and an amino group. In particular, the (meth)acryloyloxy group is preferred from the stand point of prevention of bleeding out of the antifouling agent. A number of the substituent is preferably from 1,500 to 20,000 g·mol⁻¹ in terms of a functional group equivalent weight from the standpoint of improvement in the uneven distribution of the antifouling agent and prevention of bleeding out of the antifouling agent.

R^{f} represents an organic group containing a fluorine atom and is preferably a group represented by CₓF₂ₓ₊₁(CH₂)ₚ— (wherein x represents an integer from 1 to 8, and p represents an integer from 2 to 10) or a perfluoropolyether-substituted alkyl group. b preferably represents from 0.2 to 0.4, and more preferably from 0.2 to 0.25. When b is 0.2 or more, the antifouling property is improved, whereas when b is 0.4 or less, the curing property is improved. R^{f} is preferably a perfluoroalkyl group having 8 carbon atoms.

R^{A} represents an organic group containing a polymerizable functional group and from the standpoint of ease of industrial synthesis, it is more preferred that its bond to the Si atom is a Si—O—C bond. c preferably represents from 0.4 to 0.8, and more preferably from 0.6 to 0.8. When c is 0.4 or more, the curing property is improved, whereas when c is 0.8 or less, the antifouling property is improved.

a+b+c is preferably from 2 to 2.7, and more preferably from 2 to 2.5. When a+b+c is less than 2, the uneven distribution of the compound in the surface hardly occur, whereas when a+b+c is more than 2.7, compatibility between the curing property and the antifouling property may not be attained.

In the case where the fluorine-containing compound contains a siloxane structure, the compound contains 3 or more F atoms and 3 or more Si atoms, and preferably from 3 to 17 F atoms and from 3 to 8 Si atoms in its molecule. When it contains 3 or more F atoms, the antifouling property is sufficient, whereas when it contains 3 or more Si atoms, the uneven distribution of the compound in the surface is accelerated and the antifouling property is sufficient.

In the case where the fluorine-containing compound contains a siloxane structure, the compound can be produced, for example, using a known method described in JP-A-2007-145884.

In the case where the fluorine-containing compound contains a siloxane structure, the siloxane structure may have any of straight-chain, branched and cyclic structures. Among them, the branched and cyclic structures are preferred because of good compatibility with, for example, a compound having an unsaturated double bond described hereinafter, no repelling and ease of occurrence of the uneven distribution of the compound in the surface.

As the compound in which the siloxane structure is a branched structure, a compound represented by formula (F-7) shown below is preferred.

R^{f}SiRₖ[OSiRₘ(OR^{A})₃₋ₘ]₃₋ₖ Formula (F-7)

In formula (F-7), R, R^{f} and R^{A} have the same meanings as defined above respectively, m represents 0, 1 or 2, particularly m represents 2, and k represents 0 or 1.

As the compound in which the siloxane structure is a cyclic structure, a compound represented by formula (F-8) shown below is preferred.

(R^{f}RSiO)(R^{A}RSiO)ₙ Formula (F-8)

In formula (F-8), R, R^{f} and R^{A} have the same meanings as defined above respectively, and n≧2, particularly 3≦n≦5).

Specific examples of the fluorine-containing polysiloxane compound include the compounds shown below.

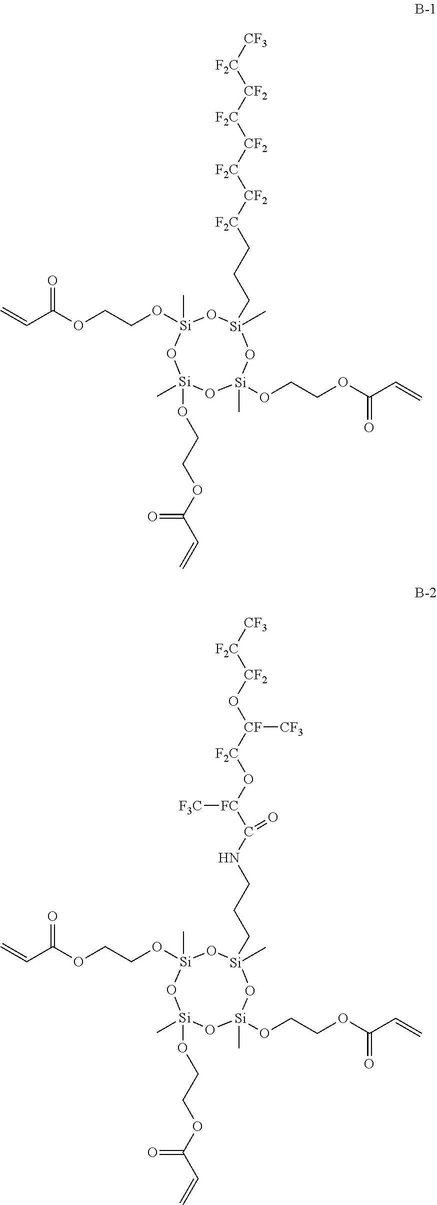

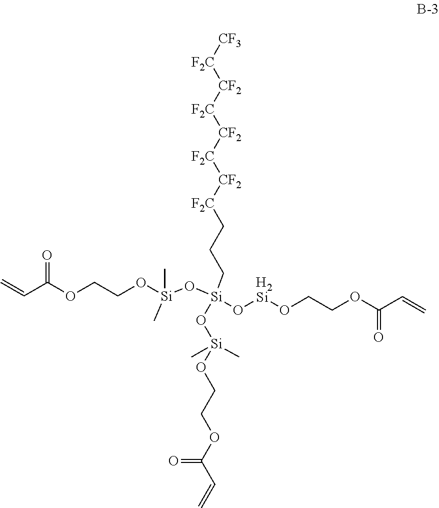

### [Molecular Weight of Fluorine-Containing Antifouling Agent]

A weight average molecular weight (Mw) of the fluorine-containing antifouling agent having a polymerizable unsaturated group can be measured by using molecular exclusion chromatography, for example, gel permeation chromatography (GPC). The Mw of the fluorine-containing antifouling agent for use in the invention is preferably from 400 to less than 5,000, more preferably from 1,000 to less than 5,000, and still more preferably from 1,000 to less than 3,500. When the Mw of the antifouling agent is 400 or more, it is preferred because the surface migration property of the antifouling agent is high. Whereas, when the Mw of the antifouling agent is less than 5,000, the surface migration of the antifouling agent is not inhibited from a coating step to a curing step so that the antifouling agent is apt to be uniformly oriented in the surface of the hardcoat layer thereby improving the antifouling property and film hardness.

In the case where the fluorine-containing compound contains a siloxane structure, the Mw of the compound is less than 15,000, preferably from 1,000 to less than 5,000, and still more preferably from 1,000 to less than 3,500.

[Amount of Fluorine-Containing Antifouling Agent Added]

An amount of the fluorine-containing antifouling agent having a polymerizable unsaturated group added is preferably from 1 to 20% by weight, more preferably from 1 to 15% by weight, still more preferably from 1 to 10% by weight, based on the total solid content of the composition for forming the hardcoat layer. When the amount is 1% by weight or more, a ratio of the antifouling agent having water/oil repellency is adequate so that sufficient antifouling property can be obtained. Whereas, when the amount is 20% by weight or less, the antifouling agent which can not be mixed with a binder component does not deposit on the surface and it is preferred because whitening of the layer or generation of white powder on the surface is prevented.

### [Polysiloxane Compound Having Weight Average Molecular Weight of 15,000 or More and Polymerizable Unsaturated Group]

The polysiloxane compound having a weight average molecular weight of 15,000 or more and a polymerizable unsaturated group, which can be used the component (a), is described below. Hereinafter, the polysiloxane compound having a weight average molecular weight of 15,000 or more and a polymerizable unsaturated group is referred to as a “polysiloxane antifouling agent”.

The polysiloxane antifouling agent is preferably represented by formula (F-6) shown below.

RₐR^{f}_{b}R^{A}_{c}SiO_{(4-a-b-c)/2} Formula (F-6)

In formula (F-6), R represents a hydrogen atom, a methyl group, an ethyl group, a propyl group or a phenyl group, R^{f} represents an organic group containing a fluorine atom, R^{A} represents an organic group containing a polymerizable unsaturated group, 0<a, 0<b, 0<c, and a+b+c<4.

a is preferably from 1 to 1.75, and more preferably from 1 to 1.5. When a is 1 or more, synthesis of the compound is industrially easy, whereas when a is 1.75 or less, compatibility between the curing property and the antifouling property can be easily attained.

The polymerizable unsaturated group in R^{A} includes the polymerizable unsaturated group for R_{A} in formula (F) described above and preferably includes a (meth)acryloyl group, a (meth)acryloyloxy group and groups wherein an appropriate hydrogen atom of these groups is substituted with a fluorine atom.

As for the polysiloxane antifouling agent, also, from the standpoint of achieving more remarkably the effects (1) to (3) described above, the polysiloxane antifouling agent preferably has a plurality of polymerizable unsaturated groups in its molecule and is more preferably a polydimethylsiloxane having a plurality of polymerizable unsaturated groups in its molecule.

The polysiloxane antifouling agent preferably includes a compound chain containing a plurality of dimethylsilyloxy units as a repeating unit and having a substituent at a terminal and/or in a side chain. The compound chain containing a dimethylsilyloxy unit as a repeating unit may further contain a structure unit other than the dimethylsilyloxy unit. The substituents are preferably present two or more and may be the same or different from each other. Examples of the preferable substituent include a (meth)acryloyl group, a (meth)acryloyloxy group, a vinyl group, an allyl group, a cinnamoyl group, an epoxy group, an oxethanyl group, a hydroxy group, a fluoroalkyl group, a polyoxyalkylene group, a carboxyl group and an amino group. In particular, the (meth) acryloyloxy group is preferred from the stand point of prevention of bleeding out of the antifouling agent. A number of the substituent is preferably from 1,500 to 20,000 g·mol⁻¹ in terms of a functional group equivalent weight from the standpoint of improvement in the uneven distribution of the antifouling agent and prevention of bleeding out of the antifouling agent.

R^{f} represents an organic group containing a fluorine atom and is preferably a group represented by CₓF₂ₓ₊₁(CH₂)ₚ— (wherein x represents an integer from 1 to 8, and p represents an integer from 2 to 10) or a perfluoropolyether-substituted alkyl group. b preferably represents from 0.2 to 0.4, and more preferably from 0.2 to 0.25. When b is 0.2 or more, the antifouling property is improved, whereas when b is 0.4 or less, the curing property is improved.

R^{A} represents an organic group containing a polymerizable functional group and from the standpoint of ease of industrial synthesis, it is more preferred that its bond to the Si atom is a Si—O—C bond. c preferably represents from 0.4 to 0.8, and more preferably from 0.6 to 0.8. When c is 0.4 or more, the curing property is improved, whereas when c is 0.8 or less, the antifouling property is improved.

a+b+c is preferably from 2 to 2.7, and more preferably from 2 to 2.5. When a+b+c is less than 2, the uneven distribution of the compound in the surface hardly occur, whereas when a+b+c is more than 2.7, compatibility between the curing property and the antifouling property may not be attained.

The polysiloxane antifouling agent contains 3 or more F atoms and 3 or more Si atoms, and preferably from 3 to 17 F atoms and from 3 to 8 Si atoms in its molecule. When it contains 3 or more F atoms, the antifouling property is sufficient, whereas when it contains 3 or more Si atoms, the uneven distribution of the compound in the surface is accelerated and the antifouling property is sufficient.

The polysiloxane antifouling agent can be produced, for example, using a known method described in JP-A-2007-145884.

As an additive having the polysiloxane structure, it is also preferred to use a reactive group-containing polysiloxane [for example, KF-100T, X-22-169AS, KF-102, X-22-37011E, X-22-164C, X-22-5002, X-22-173B, X-22-174D, X-22-167B and X-22-161AS (trade names, produced by Shin-Etsu Chemical Co., Ltd.), AK-5, AK-30 and AK-32 (trade names, produced by Toagosei Co., Ltd.), SILAPLANE FM0725 and SILAPLANE FM0721 (trade names, produced by Chisso Corp.), DMS-U22, RMS-033 and UMS-182 (trade names, produced by Gelest Inc.]. The silicone compounds described in Tables 2 and 3 in JP-A-2003-112383 can also be preferably used.

The siloxane structure contained in the polysiloxane antifouling agent may have any of straight-chain, branched and cyclic structures. Among them, the branched and cyclic structures are preferred because of good compatibility with, for example, a compound having an unsaturated double bond described hereinafter, no repelling and ease of occurrence of the uneven distribution of the compound in the surface.

### [Molecular Weight of Polysiloxane Antifouling Agent]

The weight average molecular weight of the polysiloxane antifouling agent is 15,000 or more, preferably from 15,000 to 50,000, and more preferably from 18,000 to 30,000. When the weight average molecular weight of the polysiloxane antifouling agent is less than 15,000, it is not preferred because the uneven distribution of the polysiloxane antifouling agent in the surface degrades to cause deterioration of the antifouling property and decrease in the hardness. However, in the case where the fluorine-containing compound having a polymerizable unsaturated group has the polysiloxane structure described above, the above-described problems do not occur.

The weight average molecular weight of the polysiloxane antifouling agent can be measured by using molecular exclusion chromatography, for example, gel permeation chromatography (GPC).

### [Amount of Polysiloxane Antifouling Agent Added]

An amount of the polysiloxane antifouling agent added is preferably from 1 to less than 25% by weight, more preferably from 1 to less than 20% by weight, still more preferably from 1 to less than 15% by weight, most preferably from 1 to less than 10% by weight, based on the total solid content of the composition for forming the hardcoat layer. When the amount is 1% by weight or more, a ratio of the antifouling agent having water/oil repellency is adequate so that sufficient antifouling property can be obtained. Whereas, when the amount is less than 25% by weight, the antifouling agent, which can not be mixed with a binder component, does not deposit on the surface and it is preferred because whitening of the layer or generation of white powder on the surface is prevented.

As for the distribution state of the antifouling agent in the thickness direction in the hardcoat layer, it is preferred to satisfy 51%<X/Y<100%, wherein X represents a fluorine content or a silicone content in the neighborhood of the surface of the hardcoat layer and Y represents a whole fluorine content or a whole silicone content in the hardcoat layer. When the X/Y is larger than 51%, the antifouling agent is not distributed inside the hardcoat layer, which is preferred in view of the antifouling agent and the film hardness. The neighborhood of the surface of the hardcoat layer indicates the region having a thickness up to less than 1 μm from the surface of the hardcoat layer and the fluorine content can be determined by a ratio of F⁻fragment or Si₂C₅H₁₅O⁺ fragment measured using time-of-flight secondary ion mass spectrometry (TOF-SIMS).

The antifouling agent (a) is preferably liquid or dissolved in a solvent at 20° C. The solvent can be appropriately selected according to the polarity of the compound and is preferably an organic solvent miscible with diethyl carbonate and includes an aliphatic or aromatic alcohol, ketone, eater or ether solvent. The antifouling agent soluble in diethyl carbonate is particularly preferred.

A surface tension of the antifouling agent (a) is preferably 25.0 mN/m or less, more preferably 23.0 mN/m or less, and still more preferably 16.0 mN/m or less, from the standpoint of the antifouling property.

The surface tension of the antifouling agent is represented by a surface tension of the single film thereof and can be determined in the manner shown below.

### (Method of Measuring Surface Tension of Antifouling Agent)

The antifouling agent was spin-coated on a quartz substrate and dried, when a solvent was included, to form a film. Using a contact angle meter (CA-X Type Contact Angle Meter, produced by Kyowa Interface Science Co., Ltd.) under dry conditions (20° C./65% RH), a droplet having a diameter of 1.0 mm of pure water as a liquid was made on the tip of stylus and brought into contact with the surface of the film to form the droplet on the film. The angle formed between the tangent line to the liquid droplet surface and the film surface on the side including the liquid droplet at the end point where the film was brought into contact with the liquid was measured to determine a contact angle. Further, using methylene iodide in place of pure water, the contact angle was measured in the same manner as described above, and the surface free energy was determined using to the equations shown below.

The surface free energy (γs^{v}, unit: mN/m) was defined by the sum of γs^{d} and γs^{h} (γs^{v}=γs^{d}+γs^{h}) which are obtained by using the experimentally determined contact angles of pure water H₂O and methylene iodide CH₂I₂, θ_{H2O} and θ_{CH2I2}, on the film described above and the following simultaneous equations a) and b) with reference to D. K. Owens, J. Appl. Polym. Sci., 13, 1741 (1969).

1+cos θ_{H2O}=2√γs^{d}(√γ_{H2O}^{d}/γ_{H2O}^{v})+2√γs^{h}(√γ_{H2O}^{h}/γ_{H2O}^{v}) a)

1+cos θ_{CH2I2}=2√γs^{d}(√γ_{CH2I2}^{d}/γ_{CH2I2}^{v})+2√γs^{h}(√γ_{CH2I2}^{h}/γ_{CH2I2}^{v}) b)

γ_{H2O}^{d}=21.8, γ_{H2O}^{h}=51.0, γ_{H2O}^{v}=72.8

γ_{CH2I2}^{d}=49.5, γ_{CH2I2}^{h}=1.3, γ_{CH2I2}^{v}=50.8

### [(b) Dimethyl Carbonate]

The composition for forming a hardcoat layer according to the invention contains (b) dimethyl carbonate.

When the specific antifouling agent (a) is used in combination with (b) dimethyl carbonate, the antifouling agent (a) is localized in the surface of a hardcoat layer so that the antifouling property is remarkably improved and the hardness of the layer is also increased. These effects are unique only to dimethyl carbonate among various solvents. Further, these effects particularly prominent in the case where the surface tension of the antifouling agent (a) is 25.0 MN/m or less.

It is also expected to reduce the amount of the antifouling agent added by using dimethyl carbonate.

In the optical film according to the invention, a cellulose acylate film is preferably used as a transparent base material as described hereinafter. The dimethyl carbonate (b) is a solvent which swells or dissolves a cellulose acylate film in a short time so that an adhesion property between the hardcoat layer and the cellulose acylate film is improved and when the composition is coated on a TAC (cellulose triacetate) film, for example, by a wire bar coating method or a die coating method, a leveling property is improved. In particular, a TAC film formed by a single layer casting method is liable to deteriorate the smoothness of film surface and tends to generate streak-like coating unevenness or the like caused by flatness defect of the TAC film when an antiglare layer is wet coated in comparison with a TAC film formed by a multilayer cocasting method. However, when a solvent having a boiling point of 80° C. or more, preferably 85° C. or more, is used, the generation of streak-like coating unevenness or the like caused by flatness defect is likely prevented and it is advantageous in the coating aptitude.

An organic solvent other than the dimethyl carbonate (b) may be used as a solvent, in such an extent that the adhesion property and antifouling property are not deteriorated in consideration of drying property at the coating, further improvement in the antifouling property or the like.

The organic solvent includes, for example, dibutyl ether, dimethoxyethane, diethoxyethane, propylene oxide, 1,4-dioxane, 1,3-dioxolane, 1,3,5-trioxane, tetrahydrofuran, anisole, phenetole, acetone, methyl ethyl ketone (MEK), diethyl ketone, dipropyl ketone, diisobutyl ketone, cyclopentanone, cyclohexanone, methylcyclohexanone, ethyl formate, propyl formate, pentyl formate, methyl acetate, ethyl acetate, propyl acetate, methyl propionate, ethyl propionate, γ-butyrolactone, methyl 2-methoxyacetate, methyl 2-ethoxyacetate, ethyl 2-ethoxyacetate, ethyl 2-ethoxypropionate, 2-methoxyethanol, 2-propoxyethanol, 2-butoxyethanol, 1,2-diacetoxyacetone, acetyl acetone, diacetone alcohol, methyl acetoacetate, ethyl acetoacetate, methyl alcohol, ethyl alcohol, isopropyl alcohol, n-butyl alcohol, cyclohexyl alcohol, isobutyl acetate, methyl isobutyl ketone (MIBK), 2-octanone, 2-heptanone, 2-hexanone, ethylene glycol ethyl ether, ethylene glycol isopropyl ether, ethylene glycol butyl ether, propylene glycol methyl ether, ethyl carbitol, butyl carbitol, hexane, heptanes, octane, cyclohexane, methylcyclohexane, ethylcyclohexane, benzene, toluene and xylene. The organic solvents may be used individually or as a combination of two or more thereof.

The solvent is used in such an extent that a solid content concentration of the composition for forming a hardcoat layer according to the invention is preferably from 20 to 80% by weight, more preferably from 30 to 75% by weight, and still more preferably from 40 to 70% by weight.

The dimethyl carbonate (b) is preferably used in such an amount that the antifouling agent (a) is controlled to be sufficiently unevenly distributed in the surface of hardcoat layer. From the standpoint of adjustment of solubilities of other materials contained in the hardcoat layer in the coating solution and from the standpoint of adjustment of thickness of the mixed region of the base material and hardcoat layer, the content is preferably 10% by weight or more, more preferably from 10 to 70% by weight, still more preferably from 15 to 60% by weight, based on the total amount of the solvent (total amount of organic solvent(s) which is to dissolve or disperse the components (a), (c) and (d) and includes the component (b) and if any, other organic solvent(s) other than the component (b)).

### [(c) Compound Having Unsaturated Double Bond]

The compound having an unsaturated double bond (c), which is contained in the composition for forming a hardcoat layer according to the invention, is described below.

The compound having an unsaturated double bond (c) can function as a binder and is preferably a multifunctional monomer having two or more polymerizable unsaturated groups. The multifunctional monomer having two or more polymerizable unsaturated groups can function as a curing agent and makes it possible to increase strength and scratch resistance of the coating. The number of polymerizable unsaturated groups contained is more preferably three or more.

The compound having an unsaturated double bond (c) includes a compound having polymerizable functional group, for example, a (meth) acryloyl group, a vinyl group, a styryl group or an allyl group, preferably a (meth)acryloyl group or —C(O)OCH═CH₂ group. A compound having 3 or more (meth)acryloyl groups in its molecule as described below is particularly preferably used.

Specific examples of the compound having polymerizable unsaturated bond include a (meth)acrylic acid diester of alkylene glycol, a (meth)acrylic acid diester of polyoxyalkylene glycol, a (meth) acrylic acid diester of polyhydric alcohol, a (meth) acrylic acid diester of ethylene oxide or propylene oxide adduct, an epoxy(meth)acrylate, a urethane (meth)acrylate and a polyester (meth)acrylate.

Of the compounds, an ester of a polyhydric alcohol and (meth)acrylic acid is preferred. Examples of the ester include 1,4-butanediol di(meth)acrylate, 1,6-hexanediol di(meth)acrylate, neopentyl glycol (meth)acrylate, ethylene glycol di(meth)acrylate, triethylene glycol di(meth)acrylate, pentaerythritol tetra(meth)acrylate, pentaerythritol tri(meth)acrylate, trimethylolpropane tri(meth)acrylate, EO-modified trimethyloipropane tri(meth)acrylate, PO-modified trimethyloipropane tri(meth)acrylate, EO-modified phosphoric acid tri(meth)acrylate, trimethylolethane tri(meth)acrylate, ditrimethylolpropanhe tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate and caprolactone-modified tris(acryloxyethyl) isocyanurate.

As the multifunctional acrylate compound having (meth) acryloyl groups, commercially available products can also be used. For example, NK ESTER A-TMMT produced by Shin-Nakamura Chemical Co., Ltd. and KAYARAD DPHA produced by Nippon Kayaku Co., Ltd. are exemplified.

A non-fluorine-containing multifunctional monomer is described in Paragraph Nos. [0114] to [0122] of JP-A-2009-98658, and it can also applied to the invention.

The compound having an unsaturated double bond (c) is preferably the compound having a hydrogen-bonding substituent for the reason that the surface-uneven distribution of the antifouling agent is increased and the antifouling property and film hardness can be further improved. The term “hydrogen-bonding substituent” means a substituent wherein an atom having a large electronegativity, for example, nitrogen, oxygen, sulfur or halogen and a hydrogen bond are connected with a covalent bond and specifically includes, for example, OH—, SH—, —NH—, CHO— or CHN—. A urethane (meth)acrylate or a (meth)acrylate having a hydroxy group is preferred. A commercially available multifunctional acrylate having a (meth)acryloyl group can be used. For example, NK OLIGO U4HA and NK ESTER A-TMM-3 produced by Shin-Nakamura Chemical Co., Ltd. and KAYARAD PET-30 produced by Nippon Kayaku Co., Ltd. are exemplified.

The content of the compound having an unsaturated double bond (c) in the composition for forming a hardcoat layer according to the invention is preferably from 70 to 99% by weight, more preferably from 80 to 99% by weight, based on the total solid content of the composition for forming a hardcoat layer in order to impart hardness or the like due to a sufficient polymerization ratio.

### [(d) Photopolymerization Initiator]

The photopolymerization initiator (d), which is contained in the composition for forming a hardcoat layer according to the invention, is described below.

Examples of a photopolymerization initiator include an acetophenone, a benzoin, a benzophenone, a phosphine oxide, a ketal, an anthraquinone, a thioxanthone, an azo compound, a peroxides, a 2,3-dialkyldione compound, a disulfide compound, a fluoroamine compound, an aromatic sulfonium, a lophine dimmer, an onium salt, a borate salt, an active ester, an active halogen, an inorganic complex and a coumarin. Specific examples, preferred embodiments and commercially available products of the photopolymerization initiator are described in Paragraph Nos. [0133] to [0151] of JP-A 2009-098658, and they can be preferably applied to the invention.

Further, various examples of the photopolymerization initiator are described in Saishin UV Koka Gijutsu (Latest UV Curing Technology), p. 159, Technical Information Institute Co., Ltd. (1991) and Kiyomi Kato, Shigaisen Koka System (Ultraviolet Ray Curing System), pages 65 to 148, Sogo Gijutsu Center Co., Ltd. (1989), and they are useful for the invention.

As for a commercially available photoradical polymerization initiator of photo-cleavage type, preferred examples thereof include IRGACURE 651, IRGACURE 184, IRGACURE 819, IRGACURE 907, IRGACURE 1870 (a 7/3 mixed initiator of CGI-403/Irg 184), IRGACURE 500, IRGACURE 369, IRGACURE 1173, IRGACURE 2959, IRGACURE 4265, IRGACURE 4263, IRGACURE 127, OXE 01 and the like produced by Ciba Specialty Chemicals Inc., KAYACURE DETX-S, KAYACURE BP-100, KAYACURE BDMK, KAYACURE CTX, KAYACURE BMS, KAYACURE 2-EAQ, KAYACURE ABQ, KAYACURE CPTX, KAYACURE EPD, KAYACURE ITX, KAYACURE QTX, KAYACURE BTC, KAYACURE MCA and the like produced by Nippon Kayaku Co., Ltd., ESACURE (KIP100F, KB1, EB3, BP, X33, KTO46, KT37, KIP150, TZT) and the like produced by Sartomer Company, Inc., and a mixture thereof.

The content of the photopolymerization initiator (d) in the composition for forming a hardcoat layer according to the invention is preferably from 0.5 to 8% by weight, more preferably from 1 to 5% by weight, based on the total solid content of the composition for forming a hardcoat layer for the reason that the content is set to be sufficiently large for polymerization of a polymerizable compound contained in the composition for forming a hardcoat layer and sufficiently small for preventing excessive increase of initiation point.

To the composition for forming a hardcoat layer according to the invention may be added components other than those described above. In particular, incorporation of (e) a silica fine particle is preferred for the reason that since the silica fine particle is hydrophilic, the surface-uneven distribution of the antifouling agent is increased and the antifouling property and film hardness can be further improved. In addition, it exhibits the effect of controlling refractive index and the effect for preventing curing shrinkage upon the crosslinking reaction.

### [(e) Silica Fine Particle]

The size (primary particle diameter) of the silica fine particle is preferably from 15 to less than 100 nm, more preferably from 20 to 80 nm, and most preferably from 25 to 60 nm. The average particle diameter of the silica fine particle can be determined from electron micrographs. When the particle diameter of the silica fine particle is too small, the effect of enhancing the surface-uneven distribution of the antifouling agent decreases, whereas when it is excessively large, fine irregularities are generated on the surface of hardcoat layer and the appearance (e.g., dense blackness) or integrated reflectance may be deteriorated. The silica fine particle may be any of crystalline and amorphous, may be a monodisperse particle or may be even an aggregate particle as long as the predetermined particle diameter is fulfilled. The shape is most preferably a spherical form but even when it is other than the spherical form, for example, an indefinite form, there arises no problem. Two or more silica fine particles different in the average particle size may be used in combination.

The silica fine particle for use in the invention may be subjected to a surface treatment in order to improve dispersibility in the coating solution and to increase film strength. Specific examples and preferred examples of the surface treatment method of the silica fine particle are same as those described in Paragraph Nos. [0119] to [0147] of JP-A-2007-298974, respectively.

As for specific examples of the silica fine particle, for example, MiBK-ST and MiBK-SD (silica sols each having an average particle diameter of 15 nm, produced by Nissan Chemical Industries, Ltd.) and MEK-ST-L (silica sol having an average particle diameter of 50 nm, produced by Nissan Chemical Industries, Ltd.) are preferably used.

The amount of the silica fine particle added is preferably from 5 to 40% by weight, more preferably from 15 to 30% by weight, based on the total solid content of the composition from the standpoint of assisting the increase in the uneven distribution of the antifouling agent.

### [Conductive Compound]

The hardcoat layer of the optical film according to the invention may contain a conductive compound for the purpose of imparting an antistatic property. In particular, by using a conductive compound having hydrophilicity, the surface-uneven distribution of the antifouling agent is increased and the antifouling property and film hardness can be further improved. In order to impart the hydrophilicity to the conductive compound, a hydrophilic group may be introduced into the conductive compound. The hydrophilic group preferably includes a cationic group, more preferably a quaternary ammonium salt group from the standpoint of exhibiting high conductivity and being relatively inexpensive.

The conductive compound for use in the invention is not particularly restricted and includes an ion conductive compound and an electron conductive compound. The ion conductive compound includes, for example, a cationic, anionic, nonionic or amphoteric ion conductive compound. The electron conductive compound includes an electron conductive compound which is a non-conjugated polymer or conjugated polymer formed by connecting aromatic carbon rings or aromatic hetero rings with a single bond or a divalent or higher valent connecting group. Of the compounds, a compound (cationic compound) having a quaternary ammonium salt group is preferred from the standpoint of high antistatic property, relatively inexpensive and ease uneven distribution in the region of the base material side.

As the compound having a quaternary ammonium salt group, any of a low molecular weight type and a high molecular weight type may be used, and a high molecular weight type cationic antistatic agent is preferably used because the fluctuation of antistatic property resulting, for example, from bleeding out is prevented. The high molecular weight type cationic compound having a quaternary ammonium salt group is used by appropriately selecting from known compounds and a polymer having at least one unit selected from the structural units represented by formulae (I) to (III) shown below is preferred from the standpoint of ease uneven distribution in the region of the base material side.

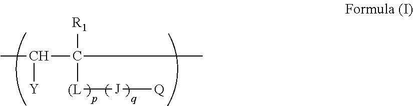

In formula (I), R₁ represents a hydrogen atom, an alkyl group, a halogen atom or a —CH₂COO⁻M⁺, Y represents a hydrogen atom or a —COO⁻M⁺, M⁺ represents a proton or a cation, L represents —CONH—, —COO—, —CO— or —O—, J represents an alkylene group or an arylene group, and Q represents a group selected from Group A shown below.

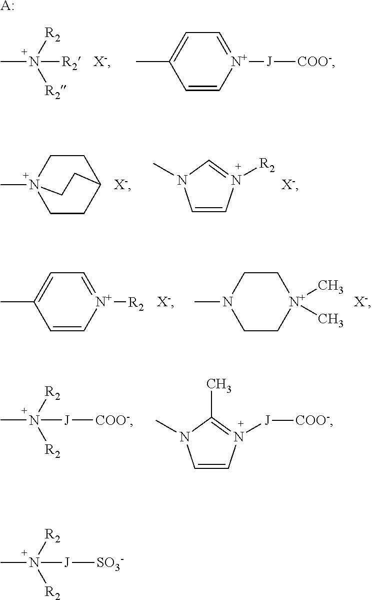

In the formulae above, R₂, R₂′ and R₂″ each independently represents an alkyl group, J represents an alkylene group or an arylene group, X⁻ represents an anion, and p and q each independently represents 0 or 1.

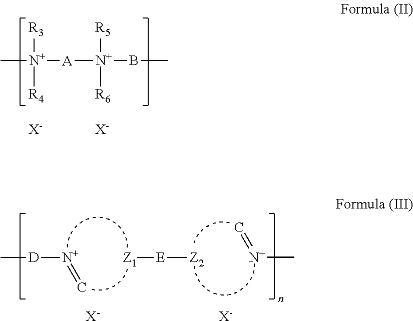

In formulae (II) and (III), R₃, R₄, R₅ and R₆ each independently represents an alkyl group, or R₃ and R₄ or R₅ and R₆ may be connected with each other to from a nitrogen-containing hetero ring. A, B and D each independently represents an alkylene group, an arylene group, an alkenylene group, an arylenealkylene group, —R₇COR₈—, —R₉COOR₁₀OCOR₁₁—, —R₁₂OCOR₁₃COOR₁₄—, —R₁₅—(OR₁₆)ₘ—, —R₁₇CONHR₁₉NHCOR₁₉—, —R₂₀OCONHR₂₁NHCOR₂₂— or —R₂₃NHCONHR₂₄NHCONHR₂₅—, E represents a single bond, an alkylene group, an arylene group, an alkenylene group, an arylenealkylene group, —R₇COR₈—, —R₈COOR₁₀OCOR₁₁—, —R₁₂OCOR₁₃COOR₁₄—, —R₁₅—(OR₁₆)ₘ—, —R₁₇CONHR₁₈NHCOR₁₉—, —R₂₀OCONHR₂₁NHCOR₂₂—, —R₂₃NHCONHR₂₄NHCONHR₂₅— or —NHCOR₂₆CONH—, R₇, R₈, R₉, R₁₁, R₁₂, R₁₄, R₁₅, R₁₆, R₁₇, R₁₉, R₂₀, R₂₂, R₂₃, R₂₅ and R₂₆ each independently represents an alkyl group, R₁₀, R₁₃, R₁₈, R₂₁ and R₂₄ each independently represents a connecting group selected from an alkylene group, an alkenylene group, an arylene group, an arylenealkylene group and alkylenearylele group, m represents a positive integer from 1 to 4, and X⁻ represents an anion. Z₁ and Z₂ each represents a nonmetallic atomic group necessary for forming a 5-membered or 6-memebered ring together with the —N═C— group and may be connected to E in the form of a quaternary salt of ≡N⁺[X⁻]—. n represents an integer from 5 to 300.

The groups in formulae (I) to (III) are described in detail below.

The halogen atom includes a chlorine atom and a bromine atom and is preferably a chlorine atom. The alkyl group is preferably a branched or a straight-chain alkyl group having from 1 to 4 carbon atoms, and more preferably a methyl group, an ethyl group or a propyl group. The alkylene group is preferably an alkylene group having from 1 to 12 carbon atoms, more preferably a methylene group, an ethylene group or a propylene group, and particularly preferably an ethylene group. The arylene group is preferably an arylene group having from 6 to 15 carbon atoms, more preferably a phenylene group, a diphenylene group, a phenylmethylene group, a phenyldimethylene group or a naphthylene group, and particularly preferably a phenymethylene group. These groups may have a substituent. The alkenylene group is preferably an alkylene group having from 2 to 10 carbon atoms and the arylenealkylene group is preferably an arylenealkylene group having from 6 to 12 carbon atoms. These groups may have a substituent.

The substituent which may be present on each group includes, for example, a methyl group, an ethyl group and a propyl group.

In formula (I), R₁ is preferably a hydrogen atom.

Y is preferably a hydrogen atom.

J is preferably a phenymethylene group.

Q is preferably a group represented by formula (VI) shown below selected from Group A wherein R₂, R₂′ and R₂″ each independently represents a methyl group.

X⁻ represents, for example, a halide ion, a sulfonic acid anion or a carboxylic acid anion, preferably a halide ion, and more preferably a chloride ion.

p and q is each preferably 0 or 1, and more preferably p is 0 and q is 1.

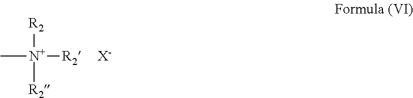

In formulae (II) and (III), R₃, R₄, R₅ and R₆ each preferably represents a substituted or unsubstituted alkyl group having from 1 to 4 carbon atoms, more preferably a methyl group or an ethyl group, and particularly preferably a methyl group. A, B and D each independently preferably represents a substituted or unsubstituted alkylene group having from 2 to 10 carbon atoms, an arylene group, an alkenylene group or an arylenealkylene group, and more preferably a phenyldimethylene group.

X⁻ represents, for example, a halide ion, a sulfonic acid anion or a carboxylic acid anion, preferably a halide ion, and more preferably a chloride ion.

E preferably represents a single bond, an alkylene group, an arylene group, an alkenylene group or an arylenealkylene group.

The 5-membered or 6-memebered ring formed by Z₁ or Z₂ together with the —N═C— group includes, for example, a diazoniabiscyclooctane ring.

Specific examples of the compound having a structural unit represented by any one of formulae (I) to (III) are set forth below, but the invention should not be construed as being limited thereto. Of the suffixes (m, x, y, z, r and numeral numbers) shown in the specific examples, m represents a number of repeating units of each unit, and x, y, z and r each represents a molar ratio of each unit.

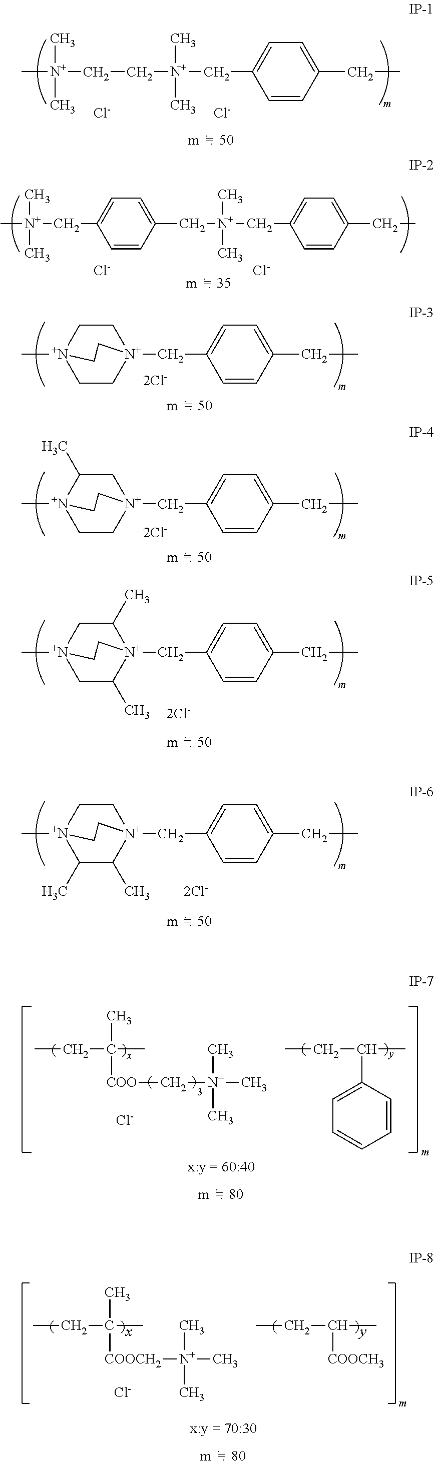

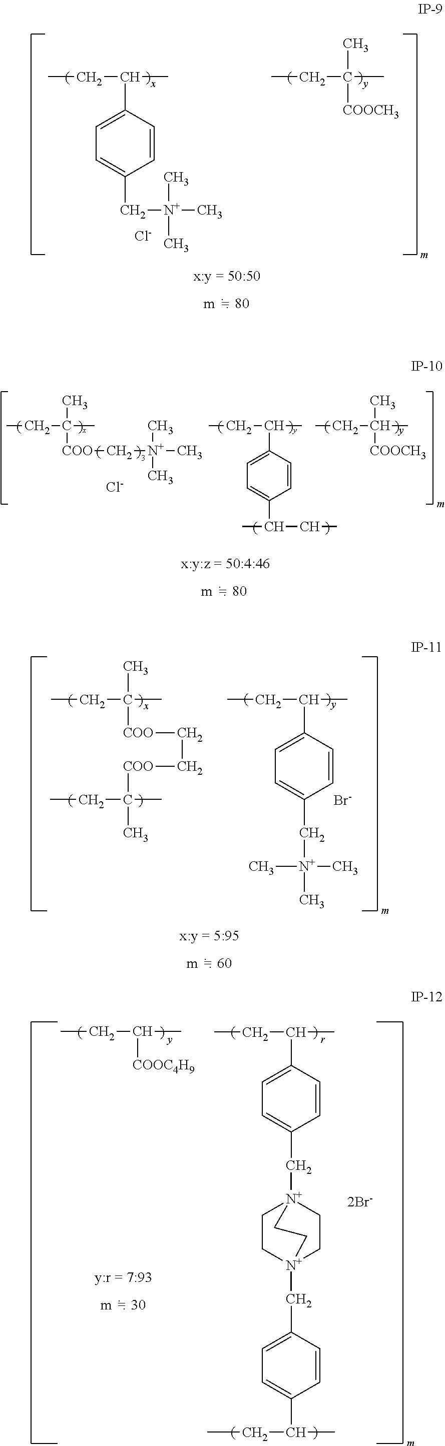

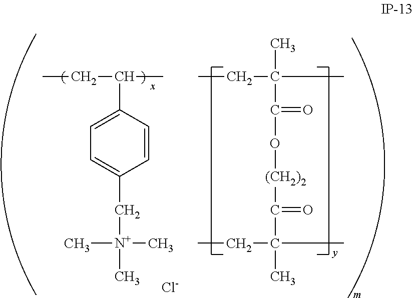

The conductive compounds illustrated above may be used individually or in combination of two or more thereof. The antistatic compound having a polymerizable group in a molecule of an antistatic agent is more preferred because it can also increase the scratch resistance (film strength) of the antistatic layer.

The electron conductive compound is preferably a non-conjugated polymer or conjugated polymer formed by connecting aromatic carbon rings or aromatic hetero rings with a single bond or a divalent or higher valent connecting group. The aromatic carbon ring in the non-conjugated polymer or conjugated polymer includes, for example, a benzene ring and the benzene ring may further form a condensed ring. The aromatic hetero ring in the non-conjugated polymer or conjugated polymer includes, for example, a pyridine ring, a pyrazine ring, a pyrimidine ring, a pyridazine ring, a triazine ring, an oxazole ring, a thiazole ring, an imidazole ring, an oxadiazole ring, thiadiazole ring, a triazole ring, a tetrazole ring, a furan ring, a thiophene ring, a pyrrole ring, an indole ring, a carbazole ring, a benzimidazole ring and an imidazopyridine ring. There rings may further form a condensed ring and may have a substituent.

The divalent or higher valent connecting group in the non-conjugated polymer or conjugated polymer includes a connecting group formed, for example, from a carbon atom, a silicon atom, a nitrogen atom, a boron atom, an oxygen atom, a sulfur atom, metal and a metal ion, and preferably a group formed from a carbon atom, a nitrogen atom, a silicon atom, a boron atom, an oxygen atom, a sulfur atom and a combination thereof. Examples of the group formed by combination include a substituted or unsubstituted methylene group, a carbonyl group, an imino group, a sulfonyl group, a sulfinyl group, an ester group, an amido group and a silyl group.

Specific examples of the electron conductive compound include conductive polyaniline, polyparaphenylene, polyparaphenylenevynylene, polythiophene, polyfuran, polypyrrole, polyselenophene, polyisothianaphthene, polyphenylene sulfide, polyacetylene, polypyridylvinylene, polyazine and derivatives thereof each of which may be substituted. The electron conductive compounds may be used individually or in combination of two or more thereof according to the purpose.

If the desired conductivity is achieved, it may be used in the form of a mixture with other polymer having no conductivity, and a copolymer of a monomer capable forming the conductive polymer with other monomer having no conductivity may also be used.

The electron conductive compound is more preferably a conjugated polymer. Examples of the conjugated polymer include polyacethylene, polydiacetylene, poly(paraphenylene), polyfluorene, polyazulene, poly(paraphenylene sulfide), polypyrrole, polythiophene, polyisothianaphthene, polyaniline, poly(paraphenylenevinylene), poly(2,5-thienylenevinylene), a multiple chain type conjugated polymer (e.g., polyperinaphthalene), a metal phthalocyanine-type polymer, other conjugated polymer (e.g., poly(paraxylylene) or poly[α-(5,5′-bithiophenediyl)benzylidene]) and derivatives thereof.

Poly(paraphenylene), polypyrrole, polythiophene, polyaniline, poly(paraphenylenevinylene), poly(2,5-thienylenevinylene) and derivatives thereof are preferred, polythiophene, polyaniline, polypyrrole and derivative thereof are more preferred, and polythiophene and a derivative thereof are still more preferred.

Specific examples of the electron conductive compound are set forth below, but the invention should not be construed as being limited thereto. In addition, for example, compounds described in WO 98/01909 are also illustrated. x and y each represents a number of repeating units of each unit.

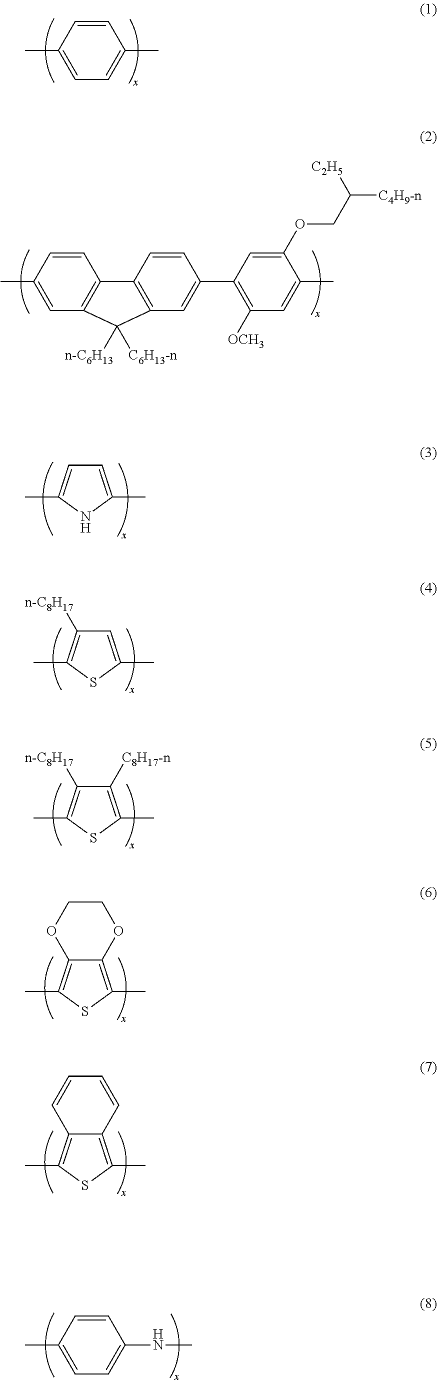

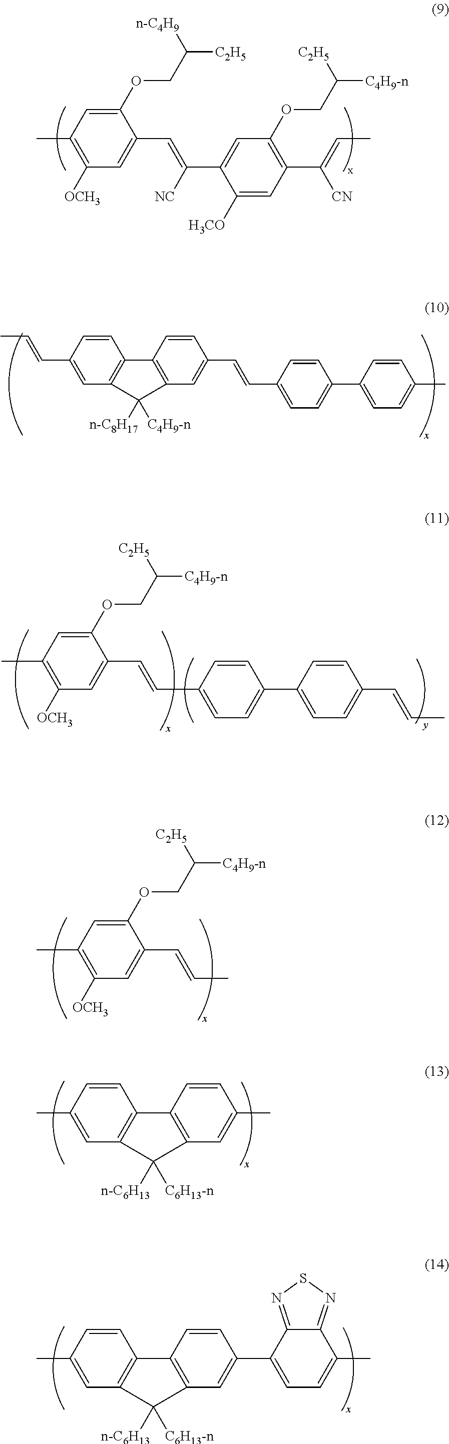

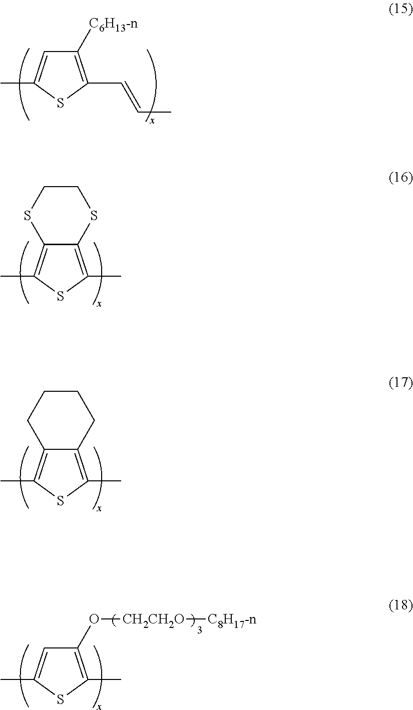

A weight average molecular weight of the electron conductive compound for use in the invention is preferably from 1,000 to 1,000,000, more preferably from 10,000 to 500,000, and still more preferably from 10,000 to 100,000. The weight average molecular weight is a weight average molecular weight measured by gel permeation chromatography and calculated in terms of polystyrene.

The electron conductive compound for use in the invention is preferably soluble in an organic solvent from the standpoint of the coating property and imparting affinity with other components. The term “soluble” as used herein means a state where the compound is dissolved in the solvent as a single molecule state or as a association state of plural single molecules or state where the compound is dispersed in the solvent as a particle having particle diameter of 300 nm or less.

Since the electron conductive compound is ordinarily dissolved in a solvent mainly composed of water, the electron conductive compound per se has hydrophilicity. In order to solubilize the electron conductive compound in an organic solvent, a compound (for example, a solubilizing-aid agent) which increases affinity with the organic solvent, a dispersant in the organic solvent or the like is added to the composition containing the electron conductive compound or a polyanion dopant subjected to a hydrophobilizing treatment is used. Although the electron conductive compound is made soluble also in the organic solvent used in the invention using the method described above, it still has the hydrophilicity so that the uneven distribution of conductive compound can be formed using the method according to the invention.

As the distribution of the conductive compound in the hardcoat layer, it is preferred that a nitrogen or sulfur atom content on the surface side of the hardcoat layer according to elemental analysis (ESCA) is from 0.5 to 5% by mole. In the range described above, good antistatic property is easily obtained. The content is more preferably from 0.5 to 3.5% by mole, and still more preferably from 0.5 to 2.5% by mole.

The composition for forming a hardcoat layer according to the invention may or may not contain the conductive compound. When the conductive compound is contained, the content of the conductive compound is preferably from 1 to 30% by weight based on the total solid content of the composition for forming a hardcoat layer.

The hardcoat layer according to the invention may further contain an additive in addition to the components described above. As such an additive which may be contained, for example, an ultraviolet absorber, a phosphite ester, hydroxamic acid, hydroxyamine, imidazole, hydroquinone or phthalic acid is exemplified for the purpose of inhibiting decomposition of the polymer. Further, an inorganic fine particle, a polymer fine particle or a silane coupling agent for the purpose of increasing the film strength, a fluorine-based compound (particularly, a fluorine-based surfactant) for the purpose of reducing a refractive index and increasing transparency, and a matting particle for the purpose of imparting an internal scattering property are exemplified. Moreover, a resin particle described, for example, in JP-A-2008-268939 for the purpose of imparting an antiglare property and a leveling agent described, for example, in JP-A-2004-331812 and JP-A-2004-163610 for the purpose of increasing uniformity of the layer are also preferably used.

### [Optical Film]

The optical film according to the invention has a hardcoat layer formed from the composition for forming a hardcoat layer as described above on a transparent base material.

According to a particularly preferred embodiment of the optical film according to the invention, the optical film has a hardcoat layer on a cellulose acylate film base material, wherein in the interface of the cellulose acylate film base material and hardcoat layer, a region in which the component of the base material and the component of the hardcoat layer are mixed is present, the hardcoat layer contains the antifouling agent described above, and the antifouling agent is localized in the surface side (side opposed to the transparent base material) of the hardcoat layer.

The term “hardcoat layer” as used herein means an entire portion containing the component of the hardcoat layer and the term “base material” as used herein means a portion not containing the component of the hardcoat layer.

In the optical film according to the invention, it is preferred to be present the region in which the component of the base material and the component of the hardcoat layer are mixed. By the mixing of the respective components, the adhesion property between the base material and the hardcoat layer is improved. A thickness of the region in which the component of the base material and the component of the hardcoat layer are mixed is preferably from 5 to 99% by weight, more preferably from 10 to 80% by weight, most preferably from 15 to 70% by weight, based on the total thickness of the hardcoat layer. When the thickness of the region in which the component of the base material and the component of the hardcoat layer are mixed is 5% or more, the adhesion property between the base material and the hardcoat layer is sufficient, whereas when the thickness of the region in which the component of the base material and the component of the hardcoat layer are mixed is 99% or less, since the component of the base material is not revealed on the uppermost surface of the hardcoat layer, an adhesion property to a further upper layer is not degraded.

The region in which the component of the base material and the component of the hardcoat layer are mixed can be determined as a portion in which both the component of the base material and the component of the hardcoat layer are detected by cutting the film by a microtome and analyzing the cut section of the film by a device of time-of-flight secondary ion mass spectrometry (TOF-SIMS) and the thickness of the region can also be determined from the information of the cut section by the TOF-SIMS. For example, in the case where a cellulose acetate film is used as the base material and a compound having an acryloyl group is used as the component (compound having an unsaturated double bond) of the hardcoat layer, C₆H₅O₂⁺ as a secondary ion indicating the base material and C₃H₃O₂⁻ as a secondary ion indicating the component (compound having an unsaturated double bond) of the hardcoat layer are respectively detected and the thickness of the region in which both secondary ions are detected to the total thickness is determined, whereby a ratio of the region in which the component of the base material and the component of the hardcoat layer are mixed can be known.

### [Transparent Base Material]

In the optical film according to the invention, although various materials may be used as the transparent base material (support), a base material containing a cellulose polymer is preferably used, and a cellulose acylate film is more preferably used.

The cellulose acylate film is not particularly restricted but when the optical film is set on a display, a cellulose triacetate film is particularly preferred from the standpoint of productivity and cost, because the cellulose triacetate film can be used as it is as a protective film for protecting a polarizing layer of a polarizing plate.

The thickness of a cellulose acylate film is ordinarily approximately from 25 to 1,000 μm, and preferably from 40 to 200 μm in view of ensuring good handling property and necessary base material strength.

As the cellulose acylate film in the invention, it is preferred to use a cellulose acetate film having an acetylation degree of 59.0 to 61.5%. The term acetylation degree means a combined acetate content based on the mass of a cellulose unit. The acetylation degree is determined according to the measurement and calculation of acetylation degree in ASTM: D-817-91 (test method of cellulose acetate or the like). The viscosity-average degree of polymerization (DP) of cellulose acylate is preferably 250 or more, and more preferably 290 or more.

It is also preferred that the cellulose acylate for use in the invention has an Mw/Mn value (wherein Mw represents a weight average molecular weight and Mn represents a number average molecular weight) determined by gel permeation chromatography close to 1.0, in other words, has a narrow molecular weight distribution. Specifically, the Mw/Mn value is preferably from 1.0 to 1.7, more preferably from 1.3 to 1.65, and most preferably from 1.4 to 1.6.

In general, the total substitution degree in cellulose acylate is not distributed evenly ⅓ each among hydroxy groups at 2-, 3- and 6-positions, but the substitution degree of the 6-position hydroxy group tends to decrease. According to the invention, it is preferred that the substitution degree of the 6-position hydroxy group is higher than those of the 2- and 3-position hydroxy groups.

The substitution degree of the 6-position hydroxy group with an acyl group is preferably 32% or more, more preferably 33% or more, particularly preferably 34% or more, of the total substitution degree. Further, it is preferred that the substitution degree of the 6-position acyl group in cellulose acylate is 0.88 or more. The 6-position hydroxy group may be substituted with an acyl group having a carbon number of 3 or more, for example, a propionyl group, a butyroyl group, a valeroyl group, a benzoyl group or an acryloyl group, other than an acetyl group. The substitution degree at each position can be determined by NMR measurement.

As the cellulose acylate, cellulose acetates obtained by using methods described in Paragraph Nos. [0043] to [0044], Example, Synthesis Example 1, Paragraph Nos. [0048] to [0049], Synthesis Example 2, and Paragraph Nos. [0051] to [0052], Synthesis Example 3 of JP-A-11-5851 can be used in the invention.

### [Physical Properties of Hardcoat Layer]

The refractive index of the hardcoat layer in the invention is preferably from 1.48 to 1.65, more preferably from 1.48 to 1.60, most preferably from 1.48 to 1.55, from the standpoint of the optical design for obtaining an antireflective performance.

The thickness of the hardcoat layer is ordinarily from 0.5 to 20 μm, preferably from 1 to 10 μm, more preferably 1 to 5 μm, from the standpoint of imparting sufficient durability and impact resistance to the optical film.

The strength of the hardcoat layer is preferably H or more, more preferably 2H or more, and most preferably 3H or more, in the pencil hardness test. Further, in the Taber test according to JIS K5400, the abrasion loss of the specimen between before and after the test is preferably smaller.

### (Method of Producing Optical Film)

The optical film according to the invention can be produced by the following method, but the invention should not be construed as being limited thereto.

First, a composition for forming a hardcoat layer is prepared. Then, the composition is coated on a transparent base material by a dip coating method, an air knife coating method, a curtain coating method, a roller coating method, a wire bar coating method, a gravure coating method or a die coating method followed by heating and drying. A microgravure coating method, a wire bar coating method or a die coating method (see, U.S. Pat. No. 2,681,294 and JP-A-2006-122889) is more preferred, and a die coating method is particularly preferred.

After the coating and drying, the layer formed from the composition for forming a hardcoat layer is cured by irradiating light, whereby the hardcoat layer is formed. If desired, other layer may be previously coated on the transparent base material, and the hardcoat layer may be formed thereon. Thus, the optical film according to the invention is obtained. Also, if desired, other layer as described above may be provided. In the method of producing an optical film according to the invention, a plurality of layers may be coated simultaneously or sequentially.

A particularly preferred embodiment of the method of producing an optical film according to the invention is a method of producing an optical film having a hardcoat layer on a cellulose acylate film base material comprising coating the composition for forming a hardcoat layer as described above on the base material and curing to form a hardcoat layer.

### [Protective Film for Polarizing Plate]

In the case of using the optical film as a surface protective film of a polarizing film (protective film for polarizing plate), the adhesion property to the polarizing film composed of a polyvinyl alcohol as the main component can be improved by hydrophilizing (conducting a so-called saponification treatment) the surface of the transparent base material on the side opposite to the side having the thin-film layer, that is, the surface on the side to be laminated with the polarizing film.

It is also preferred that of the two protective films of the polarizer, the film other than the optical film is an optical compensation film having an optical compensation layer comprising an optically anisotropic layer. The optical compensation film (retardation film) can improve the viewing angle characteristics on the liquid crystal display screen.

Although a known optical compensation film can be used as the optical compensation film, an optical compensation film described in JP-A-2001-100042 is preferred from the standpoint of enlarging the viewing angle.

The saponification treatment is described below. The saponification treatment is a treatment comprising immersing an optical film in a warmed aqueous alkali solution for a certain period of time, washed with water, and washed with an acid for neutralization. The saponification treatment may be performed under any treatment conditions as long as the surface of the transparent base material on the side to be laminated with the polarizing film is hydrophilized. Therefore the concentration of a treatment agent, the temperature of a treatment agent solution and the treatment time are appropriate determined. Ordinarily, from the necessity of ensuring productivity, the treatment conditions are determined so as to complete the treatment within 3 minutes. As for the ordinary conditions, the alkali concentration is from 3 to 25% by weight, the treatment temperature is from 30 to 70° C., and the treatment time is from 15 seconds to 5 minutes. The alkali species for use in the alkali treatment is preferably sodium hydroxide or potassium hydroxide, the acid for use in the acid washing is preferably sulfuric acid, and the water for use in the water washing is preferably ion exchanged water or pure water.

The antistatic layer of the optical film according to the invention can well maintain the antistatic property even when it is exposed to an aqueous alkali solution by the saponification treatment as above.

When the optical film according to the invention is used as the surface protective film of a polarizing film (protective film for polarizing plate), the cellulose acylate film is preferably a cellulose triacetate film.

### [Polarizing Plate]

The polarizing plate according to the invention is described below.

The polarizing plate according to the invention is a polarizing plate having a polarizing film and two protective films for protecting both surfaces of the polarizing film, wherein at least one of the surface protective films is the optical film or antireflective film according to the invention.

Examples of the polarizing film include an iodine-type polarizing film, a dye-type polarizing film using a dichromatic dye and a polyene-type polarizing film. The iodine-type polarizing film and dye-type polarizing film can ordinarily produced by using a film of polyvinyl alcohol type.

A construction is preferred in which the cellulose acylate film of the optical film is adhered to the polarizing film, if desired, through, for example, an adhesive layer composed of polyvinyl alcohol, and on the other side of the polarizing film, a protective film is provided. The protective film may have an adhesive layer on the side opposite to the side on which the polarizing film is placed.

By using the optical film according to the invention as a protective film for polarizing plate, the polarizing plate excellent in the physical strength, antistatic property and durability can be produced.

In addition, the polarizing plate according to he invention can also have an optical compensation function. In this case, it is preferred that, of two surface protective films, only either the surface protective film on the front side or the surface protective film on the rear side is formed with the optical film described above and the surface protective film on the side opposite to the side on which the polarizing plate has the optical film is an optical compensation film.

By producing the polarizing plate using the optical film according to the invention as one of the protective films for polarizing plate and an optical compensation film having optical anisotropy as the other of the protective films for polarizing plate, the contrast and up/down left/right viewing angle of liquid crystal display device in a bright room can be further improved.

### [Image Display Device]

The image display device according to the invention has the optical film, antireflective film or polarizing plate according to the invention on the uppermost surface of its display.

The optical film, antireflective film or polarizing plate according to the invention can be preferably used in an image display device, for example, a liquid crystal display device (LCD), a plasma display panel (PDP), an electroluminescence display (ELD) or a cathode ray tube display (CRT).

In particular, it can be advantageously used in an image display device, for example, a liquid crystal display device, and it is particularly preferred to use the optical film as the uppermost layer on the backlight side of a liquid crystal cell in a transmission/semi-transmission liquid crystal display device.

The liquid crystal display device ordinarily has a liquid crystal cell and two polarizing plates disposed on both sides of the liquid crystal cell, and the liquid crystal cell bears a liquid crystal between two electrode base materials. Further, one optically anisotropic layer is disposed between the liquid crystal cell and one of the polarizing plates, or two optically anisotropic layers may be disposed between the liquid crystal cell and both of the polarizing plates, respectively.

The liquid crystal cell is preferably in a TN mode, a VA mode, an OCB mode, an IPS mode or an ECB mode.

### Examples

The present invention will be described in more detail with reference to the following examples, but the invention should not be construed as being limited thereto. Unless otherwise indicated specifically, all parts and percentages in the examples are on a weight basis.

### [Production of Optical Film]

A coating solution for forming a hardcoat layer was prepared and a hardcoat layer was formed on a transparent base material in the manner shown below to produce Optical film samples 1 to 23.

### (Preparation of Coating Solution A-1 for Hardcoat Layer)

The composition shown below was charged into a mixing tank and the mixture was stirred and filtered through a filter made of polypropylene having a pore size of 0.4 μm to prepare Coating solution A-1 for hardcoat layer (solid content concentration: 50% by weight).

| | |
|---|---|
| Dimethyl carbonate | 300 parts by weight |
| Methyl isobutyl ketone | 700 parts by weight |
| Mixture of pentaerythritol tetraacrylate and | 920 parts by weight |
| pentaerythritol triacrylate (PET 30, | |
| produced by Nippon Kayaku Co., Ltd.) | |
| Photopolymerization initiator (IRGACURE | 30 parts by weight |
| 184, produced by Ciba Specialty Chemicals | |
| Inc.) | |
| Reactive silicone (RMS-033, produced by | 50 parts by weight |
| Shin-Etsu Chemical Co., Ltd.) | |

In a similar manner to the preparation of Coating solution A-1 for hardcoat layer, the respective components were mixed as shown in Table 1 below, dissolved in solvents and adjusted so as to have the ratio shown in Table 1, thereby preparing Coating solutions A-2 to A-23 for hardcoat layer having solid content concentration of 50% by weight, respectively. In Table 1, the content of Solvent 1 and content of Solvent 2 are indicated as % by weight of the total content of Solvent 1 and Solvent 2, respectively.

TABLE 1

| | Composition for Hardcoat Layer | | | | | | | | | | | | | | |
|---|---|---|---|---|---|---|---|---|---|---|---|---|---|---|---|
| | | Compound having | | | | | | | | | | | | | |
| | Com- | Unsaturated | | Irg. | Antifouling Agent | | | | Other | | | | | | |
| Sam- | posi- | Double Bond | | 184 | | Molec- | | | Additive | | Solvent 1 | | Solvent 2 | | |
| ple | tion | | Con- | Con- | | ular | Surface | Con- | | Con- | | Con- | | Con- | Re- |
| No. | Name | Kind | tent* | tent* | Kind | Weight | Tension | tent* | Kind | tent* | Kind | tent | Kind | tent | marks |
| 1 | A-1 | PET 30 | 92% | 3% | RMS- | 28,000 | 24 mN/m | 5% | — | — | Dimethyl | 30% | MIBK | 70% | Invention |
| | | | | | 033 | | | | | | Carbonate | | | | |
| 2 | A-2 | PET 30 | 92% | 3% | X22- | 3,300 | 24 mN/m | 5% | — | — | Dimethyl | 30% | MIBK | 70% | Compar- |
| | | | | | 164B | | | | | | Carbonate | | | | ative |
| | | | | | | | | | | | | | | | Example |
| 3 | A-3 | PET 30 | 92% | 3% | a-5 | 446 | 20 mN/m | 5% | — | — | Dimethyl | 30% | MIBK | 70% | Invention |
| | | | | | | | | | | | Carbonate | | | | |
| 4 | A-4 | PET 30 | 92% | 3% | MF-1 | 1,550 | 15 mN/m | 5% | — | — | Dimethyl | 30% | MIBK | 70% | Invention |
| | | | | | | | | | | | Carbonate | | | | |
| 5 | A-5 | PET 30 | 92% | 3% | OPTOOL | — | 15 mN/m | 5% | — | — | Dimethyl | 30% | MIBK | 70% | Invention |
| | | | | | DAC | | | | | | Carbonate | | | | |
| 6 | A-6 | PET 30 | 92% | 3% | d-4 | 1,600 | 14 mN/m | 5% | — | — | Dimethyl | 30% | MIBK | 70% | Invention |
| | | | | | | | | | | | Carbonate | | | | |
| 7 | A-7 | PET 30 | 92% | 3% | d-4 | 1,600 | 14 mN/m | 5% | — | — | Diethyl | 30% | MIBK | 70% | Compar- |
| | | | | | | | | | | | Carbonate | | | | ative |
| | | | | | | | | | | | | | | | Example |
| 8 | A-8 | PET 30 | 92% | 3% | d-4 | 1,600 | 14 mN/m | 5% | — | — | Ethyl | 30% | MIBK | 70% | Compar- |
| | | | | | | | | | | | Acetate | | | | ative |
| | | | | | | | | | | | | | | | Example |
| 9 | A-9 | PET 30 | 92% | 3% | d-4 | 1,600 | 14 mN/m | 5% | — | — | Cyclo- | | MIBK | 70% | Compar- |
| | | | | | | | | | | | hexanone | | | | ative |
| | | | | | | | | | | | | | | | Example |
| 10 | A-10 | PET 30 | 92% | 3% | d-4 | 1,600 | 14 mN/m | 5% | — | — | MEK | | MIBK | 70% | Compar- |
| | | | | | | | | | | | | | | | ative |
| | | | | | | | | | | | | | | | Example |
| 11 | A-11 | PET 30 | 92% | 3% | d-4 | 1,600 | 14 mN/m | 5% | — | — | Methyl | | MIBK | 70% | Compar- |
| | | | | | | | | | | | Acetate | | | | ative |
| | | | | | | | | | | | | | | | Example |
| 12 | A-12 | PET 30 | 92% | 3% | d-4 | 1,600 | 14 mN/m | 5% | — | — | Acetone | | MIBK | 70% | Compar- |
| | | | | | | | | | | | | | | | ative |
| | | | | | | | | | | | | | | | Example |
| 13 | A-13 | PET 30 | 92% | 3% | d-4 | 1,600 | 14 mN/m | 5% | — | — | Dimethyl | 10% | MIBK | 90% | Invention |
| | | | | | | | | | | | Carbonate | | | | |
| 14 | A-14 | PET 30 | 97% | 3% | d-4 | 1,600 | 14 mN/m | 5% | — | — | Dimethyl | 5% | MIBK | 95% | Invention |
| | | | | | | | | | | | Carbonate | | | | |
| 15 | A-15 | PET 30 | 92% | 3% | d-4 | 1,600 | 14 mN/m | 5% | — | — | — | — | MIBK | 100% | Compar- |
| | | | | | | | | | | | | | | | ative |
| | | | | | | | | | | | | | | | Example |
| 16 | A-16 | PET 30 | 82% | 3% | RMS- | 28,000 | 24 mN/m | 5% | MIBK- | 10% | Dimethyl | 30% | MIBK | 70% | Invention |
| | | | | | 033 | | | | ST | | Carbonate | | | | |
| 17 | A-17 | PET 30 | 72% | 3% | RMS- | 28,000 | 24 mN/m | 5% | MIBK- | 20% | Dimethyl | 30% | MIBK | 70% | Invention |
| | | | | | 033 | | | | ST | | Carbonate | | | | |
| 18 | A-18 | PET 30 | 72% | 3% | d-4 | 1,600 | 14 mN/m | 5% | MIBK- | 20% | Dimethyl | 30% | MIBK | 70% | Invention |
| | | | | | | | | | ST | | Carbonate | | | | |
| 19 | A-19 | A-TMM- | 92% | 3% | d-4 | 1,600 | 14 mN/m | 5% | — | — | Dimethyl | 30% | MIBK | 70% | Invention |
| | | 3 | | | | | | | | | Carbonate | | | | |
| 20 | A-20 | A-TMMT | 92% | 3% | d-4 | 1,600 | 14 mN/m | 5% | — | — | Dimethyl | 30% | MIBK | 70% | Invention |
| | | | | | | | | | | | Carbonate | | | | |
| 21 | A-21 | A-TMMT | 87% | 3% | d-4 | 1,600 | 14 mN/m | 5% | IP-9 | 5% | Dimethyl | 30% | MIBK | 70% | Invention |
| | | | | | | | | | | | Carbonate | | | | |
| 22 | A-22 | A-TMMT | 82% | 3% | d-4 | 1,600 | 14 mN/m | 5% | IP-9 | 10% | Dimethyl | 30% | MIBK | 70% | Invention |
| | | | | | | | | | | | Carbonate | | | | |
| 23 | A-23 | PET 30 | 92% | 3% | — | — | — | — | — | — | Dimethyl | 30% | MIBK | 70% | Compar- |
| | | | | | | | | | | | Carbonate | | | | ative |
| | | | | | | | | | | | | | | | Example |

*The numerical value of the content of each component is indicated as a ratio (% by weight) of solid content of each component based on the solid content of total components in the coating solution.

The compounds used are shown below.

MIBK-ST: silica sol (MIBK-ST, solid content: 30% by weight, produced by Nissan Chemical Industries, Ltd.)
Polymerization initiator Irgacure 184: (Irg. 184, produced by Ciba Specialty Chemicals Inc.)
RMS-033: reactive group-containing polysiloxane (Mw: 28,000, produced by Gelest, Inc.)
X22-164B: reactive silicone (Mw: 3,300, produced by Shin-Etsu Chemical Co., Ltd.)
IP-9: Conductive compound IP-9 described hereinbefore
OPTOOL DAC: fluorine-based compound (produced by Daikin Industries, Ltd.)
d-4: Compound (d-4) of formula (F-4) described hereinbefore
a-5: Compound a-5 of formula (F-1) described hereinbefore
A-TMM-3: pentaerythritol triacrylate (produced by Shin-Nakamura Chemical Co., Ltd)
A-TMMT: pentaerythritol tetraacrylate (produced by Shin-Nakamura Chemical Co., Ltd)
MF-1: fluorine-containing unsaturated compound described in Example of WO 2003/022906 shown below

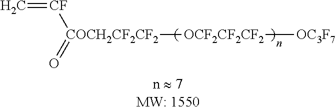

### (Production of Hardcoat Layer A-1)

On a triacetyl cellulose film (TD80UF, produced by FUJIFILM Corp., refractive index: 1.48) having a thickness of 80 μm as the transparent base material was coated Coating solution A-1 for hardcoat layer described above using a gravure coater and dried at 100° C. Then, the coated layer was cured by irradiating an ultraviolet ray at an illuminance of 400 mW/cm² and an irradiation dose of 150 mJ/cm² using an air-cooled metal halide lamp (produced by Eye Graphics Co., Ltd.) of 160 W/cm while purging with nitrogen so as to give an atmosphere having an oxygen concentration of 1.0% by volume or less, whereby Hardcoat layer A-1 having a thickness of 12 μm was formed.

Hardcoat layers A-2 to A-23 were produced in the same manner as above using Coating solutions A-2 to A-23 for hardcoat layer, respectively. The refractive index of the hardcoat layer was determined by coating the coating solution for hardcoat layer on a glass plate so as to have a thickness of about 4 μm and measuring by Multi-wavelength Abbe Refractometer DR-M2 (produced by ATAGO Co., Ltd.). A refractive index measured using a filter, “Interference Filter 546(e) nm for DR-M2, M4, parts number: RE-3523”, was employed as the refractive index at a wavelength of 550 nm.

### (Evaluation of Optical Film)

Various performances of the optical film were evaluated according to the methods described below. The results obtained are shown in Table 2.

### (1) Observation of Interface of Base Material and Hardcoat Layer

The optical film was cut by a microtome and the cut section of the film was analyzed by a device of time-of-flight secondary ion mass spectrometry (TOF-SIMS), thereby observing the state of the interface. The portion in which both the component of the base material and the component of the hardcoat layer were detected was regarded as a region in which the component of the base material and the component of the hardcoat layer were mixed and a thickness of the region was also determined from the information of the cut section by the TOF-SIMS, thereby calculating a ratio of the thickness of the region in which the component of the base material and the component of the hardcoat layer were mixed to the total thickness of the hardcoat layer. Also, when an amount of fluorine or silicone in the neighborhood of surface of the hardcoat layer was taken as X and the total amount of fluorine or silicone in the hardcoat layer is taken as Y, X/Y was calculated. As the secondary ion indicating the base material and the secondary ion indicating the component (compound having an unsaturated double bond) of the hardcoat layer, C₆H_{S}O₂⁺ and C₃H₃O₂⁻ were detected, respectively. As the secondary ion indicating the antifouling agent, F⁻ fragment or Si₂C₅H₁₅O⁺ fragment was detected.

### (2) Evaluation of Antifouling Property

The optical film was fixed on a glass surface with an adhesive, and a circle of 5 mm in diameter was drawn thereon in three turns with a pen tip (fine) of a black magic marker, MACKY GOKUBOSO (MACKY SUPERFINE) (trade name, produced by ZEBRA Co., Ltd.), under the conditions of 25° C. and 60% RH. After 10 seconds, the surface of the optical film was wiped off with a 10-ply folded and bundled BEMCOT (trade name, produced by Asahi Kasei Fibers Corp.) by moving the bundle back and forth 2 times under a load large enough to make a dent in the BEMCOT bundle. The drawing and wiping were repeated under the above-described conditions until the magic marker stain could not be eliminated by the wiping, and the number of repetitions taken to wipe off the magic marker stain was measured to evaluate the antifouling property according the criteria shown below. A to C are acceptable.

A: The number of repetitions until the magic marker stain cannot be eliminated is 30 times or more.
B: The number of repetitions until the magic marker stain cannot be eliminated is from 5 times to less than 30 times.
C: The number of repetitions until the magic marker stain cannot be eliminated is from 1 time to less than 5 times.
D: The magic marker stain can not be eliminated by the wiping.

### (3) Evaluation of Adhesion Property

The adhesion property was evaluated according to a cross-cut peel test described in JIS K 5400. Specifically, the surface of sample was cut in a grid pattern having 100 squares with dimensions of 1×1 mm and subjected to the adhesion test using a cellophane tape (produced by Nichiban CO., Ltd.). A new cellophane tape was attached to the sample and then peeled off to evaluate the adhesion property according the criteria shown below.

A: Peeling off of the square did not occur.
B: 90% or more of the squares remained without being peeled off and there was no problem while the peeling off slightly occurred.
C: From 70% to less than 90% of the squares remained without being peeled off and there was almost no problem while the peeling off slightly occurred.
D: Less than 70% of the squares remained without being peeled off and there was a serious problem.

### (4) Evaluation of Pencil Hardness

The pencil hardness evaluation described in JIS K 5400 was conducted. After the optical film was subjected to humidity control at temperature of 25° C. and humidity of 60% RH for 2 hours, the pencil hardness was evaluated using pencils for test defined by JIS S 6006. As for the hardcoat performance, the hardness of 2.5H or more is preferred.

### (5) Evaluation of Dust Resistance

The transparent base material side of the optical film was laminated on a CRT surface and the laminate was used for 24 hours in a room having from 100 to 2,000,000 particles of dust of 0.5 μm or more and tissue paper scraps per 1 ft³ (cubic feet). The number of particles of dust and the number of the tissue paper scrapes attached per 100 cm² of the optical film were measured and the average value thereof was determined and evaluated according to the criteria shown below.

A: Less than 20 pieces are determined and the dusts almost did not attach.
B: From 20 to less than 200 pieces are determined and there was no problem while a small amount of the dusts attached.
C: 200 or more pieces are determined and a large amount of the dusts attached.

TABLE 2

| | Results of Evaluation | | | | | | |
|---|---|---|---|---|---|---|---|
| | Ratio of | Adhesion | Present Region | | | | |
| Sample | Thickness of | Property HC-Base | of Antifouling | Antifouling | Pencil | Dust | |
| No. | Mixed Region | Material | Agent | Property | Hardness | Resistance | Remarks |
| 1 | 25% | B | 80% | B | 2.8H | C | Invention |
| 2 | 25% | B | 90% | D | 2.2H | C | Comparative |
| | | | | | | | Example |
| 3 | 25% | B | 70% | B | 2.8H | C | Invention |
| 4 | 25% | B | 80% | B | 3H | C | Invention |
| 5 | 25% | B | 85% | B | 3H | C | Invention |
| 6 | 25% | B | 95% | B | 3H | C | Invention |
| 7 | 0% | D | 55% | C | 2.5H | C | Comparative |
| | | | | | | | Example |
| 8 | 5% | D | 30% | D | 2.5H | C | Comparative |
| | | | | | | | Example |
| 9 | 8% | B | 30% | D | 2.3H | C | Comparative |
| | | | | | | | Example |
| 10 | 25% | B | 30% | D | 2.2H | C | Comparative |
| | | | | | | | Example |
| 11 | 50% | B | 30% | D | 2H | C | Comparative |
| | | | | | | | Example |
| 12 | 45% | B | 30% | D | 2H | C | Comparative |
| | | | | | | | Example |
| 13 | 8% | B | 88% | B | 2.5H | C | Invention |
| 14 | 3% | B | 52% | C | 2.2H | C | Invention |
| 15 | 0% | B | 30% | D | 2H | C | Comparative |
| | | | | | | | Example |
| 16 | 22% | B | 92% | B | 3.2H | C | Invention |
| 17 | 20% | B | 85% | A | 3.5H | C | Invention |
| 18 | 20% | B | 95% | A | 3.5H | C | Invention |
| 19 | 25% | B | 82% | B | 3H | C | Invention |
| 20 | 25% | B | 65% | C | 2.8H | C | Invention |
| 21 | 22% | B | 75% | B | 3H | B | Invention |
| 22 | 20% | B | 85% | A | 3.2H | A | Invention |
| 23 | 20% | D | — | D | 3H | C | Comparative |
| | | | | | | | Example |

As is apparent from the results shown in Table 2, the optical film which is improved in the antifouling property and is excellent in the adhesion property and pencil hardness can be obtained by using the composition for forming a hardcoat layer according to the invention. Further, in Sample Nos. 21 and 22 each containing a conductive compound, the dust resistances are ranked B and A respectively and the good dust resistance can also be imparted.

### (Saponification Treatment of Optical Film)

Optical film of Sample No. 6 described above was subjected to the following treatment. Specifically, an aqueous 1.5 mol/l sodium hydroxide solution was prepared and kept at 55° C. An aqueous 0.01 mol/l dilute sulfuric acid solution was prepared and kept at 35° C. The optical film was immersed in the aqueous sodium hydroxide solution for 2 minutes and then immersed in water to thoroughly wash away the aqueous sodium hydroxide solution. Subsequently, the optical film was immersed in the aqueous dilute sulfuric acid solution for one minute and then immersed in water to thoroughly wash away the aqueous dilute sulfuric acid solution. Finally, the optical film was thoroughly dried at 120° C.

Thus, the optical film subjected to the saponification treatment was prepared.

### (Preparation of Polarizing Plate)

A triacetyl cellulose film having a thickness of 80 μm (TAC-TD80U, produced by FUJIFILM Corp.) which had been immersed in an aqueous 1.5 mol/l NaOH solution at 55° C. for 2 minutes, neutralized and then washed with water and the optical film subjected to the saponification treatment were adhered to the both surfaces of a polarizer prepared by adsorbing iodine to polyvinyl alcohol and stretching, in order to protect the both surfaces, thereby preparing a polarizing plate (Sample No. 24).

Sample No. 24 was stuck on the surface of an organic EL display with an adhesive so as to face the hardcoat layer outwards. The good display performance was obtained without the occurrence of scratch or surface state unevenness and also the magic maker stain was well wiped off.

For the purpose of reference, a molecular weight, an SP value, a boiling point, a cellulose triacetate (TAC) solubility and an antifouling property of each solvent are shown in Table 3 below.

### (SP Value)

The SP value is a solubility parameter of a compound and a numerical indicating how much the compound can dissolve in a solvent or the like. It has the same meaning as polarity which is frequently used with respect to an organic compound. The larger the SP value, the higher the polarity. The Sp value is a numerical value calculated, for example, according to a Fedors estimation method (Hideki Yamamoto, SP Chi Kiso Oyo to Keisanhoho (Fundament, Application and Calculation Method of SP Value), page 66, published by Johokiko Co., Ltd. (Mar. 31, 2005)).

### (Tac Solubility)

The TAC solubility S of a solvent can be evaluated by the following method. A base material film having weight of M was immersed in the solvent for 5 minutes, taken out from the solvent (when the film was extremely softened, it was filtered) and dried in an oven at 200° C. for one minute. Then, the film was again weighed to obtain weight of M′ and from the amount of the weight change of the base material film, the TAC solubility S was determined according to the following formula:

TAC solubility S=amount of weight change of base material film=(M−M′)/M×100 (% by weight)

The evaluation was conducted according to the criteria shown below.

A: 50%<S≦100%, the solvent dissolved the base material very much.
B: 30%<S≦50%, the solvent dissolved the base material.
C: 5%<S≦30%, although the solvent dissolved somewhat the base material, the effect is small.
D: 0%≦S<5%, the solvent hardly dissolved the base material.

TABLE 3

| | | | | Boiling | | Anti- |
|---|---|---|---|---|---|---|
| Sample | | Molecular | SP | Point | TAC | fouling |
| No. | Solvent | Weight | Value | (° C.) | Solubility | Property |
| 6 | Dimethyl | 90 | 24.1 | 90 | B | B |
| | Carbonate | | | | | |
| 7 | Diethyl | 118 | 22.0 | 127 | D | C |
| | Carbonate | | | | | |
| 8 | Ethyl | 88 | 21.8 | 77.1 | D | D |
| | Acetate | | | | | |
| 9 | Cyclo- | 98 | 22.2 | 156 | C | D |
| | hexanone | | | | | |
| 10 | MEK | 72 | 22.3 | 79.6 | B | D |
| 11 | Methyl | 74 | 22.8 | 57.8 | A | D |
| | Acetate | | | | | |
| 12 | Acetone | 58 | 23.5 | 56.2 | A | D |

As is apparent from the results shown in Table 3, the solvents which have the physical properties (molecular weight, SP value, boiling point and TAC solubility) similar to those of dimethyl carbonate according to the invention do not exhibit the effect of localization of the antifouling agent as exhibited by dimethyl carbonate. From these results, it can also be seen that it is unexpected to obtain the particular effects according to the invention by using dimethyl carbonate.

What is claimed is:

1. A composition for forming a hardcoat layer comprising the following components (a), (b), (c) and (d):
(a): at least one antifouling agent selected from a fluorine-containing compound having a polymerizable unsaturated group and a polysiloxane compound having a weight average molecular weight of 15,000 or more and a polymerizable unsaturated group,
(b): dimethyl carbonate,
(c): a compound having an unsaturated double bond,
(d): a photopolymerization initiator.

2. The composition for forming a hardcoat layer as claimed in claim 1, wherein the antifouling agent (a) is a fluorine-containing compound having a polymerizable unsaturated group, and the fluorine-containing compound has a perfluoropolyether group and a plurality of polymerizable unsaturated groups in a molecule thereof.

3. The composition for forming a hardcoat layer as claimed in claim 2, wherein the fluorine-containing compound has four or more polymerizable unsaturated groups in a molecule thereof.

4. The composition for forming a hardcoat layer as claimed in claim 2, wherein the fluorine-containing compound has a perfluoropolyether group represented by —(CF₂O)ₚ—(CF₂CF₂O)_{q}—, wherein p and q each independently represents an integer of from 0 to 20, provided that p+q is an integer of 1 or more.

5. The composition for forming a hardcoat layer as claimed in claim 2, wherein the fluorine-containing compound has a weight average molecular weight of from 1,000 to less than 5,000.

6. The composition for forming a hardcoat layer as claimed in claim 1, wherein the antifouling agent (a) is a polysiloxane compound having a weight average molecular weight of 15,000 or more and a polymerizable unsaturated group, and the polysiloxane compound is a dimethylsiloxane having a plurality of polymerizable unsaturated groups in a molecule thereof.

7. The composition for forming a hardcoat layer as claimed in claim 1, wherein the antifouling agent (a) has a surface tension of 25.0 mN/m or less.

8. The composition for forming a hardcoat layer as claimed in claim 1, which further comprises (e) a silica fine particle.

9. The composition for forming a hardcoat layer as claimed in claim 1, the compound (c) having an unsaturated double bond has a hydrogen-bonding substituent.

10. The composition for forming a hardcoat layer as claimed in claim 1, which further comprises a conductive compound.

11. The composition for forming a hardcoat layer as claimed in claim 1, wherein a content of the dimethyl carbonate (b) is 10% by weight or more based on a total solvent.

12. An optical film comprising a transparent base material and a hardcoat layer formed from the composition as claimed in claim 1.

13. The optical film as claimed in claim 12, wherein the transparent base material is a cellulose acylate film.

14. A polarizing plate comprising the optical film as claimed in claim 12 as a protective film for the polarizing plate.

15. An image display device comprising the optical film as claimed in claim 12.

16. A method for producing an optical film comprising a hardcoat layer and a cellulose acylate film base material, the method comprising: applying the composition as claimed in claim 1 onto the cellulose acylate film base material; and curing the applied composition to form a hardcoat layer.
